(19) United States
(12) Patent Application Publication
(10) Pub. No.: US 2026/0039366 A1
(43) Pub. Date: Feb. 5, 2026

(54) DYNAMIC MODEL MANAGEMENT AND POST-DEPLOYMENT VERIFICATION FOR BEAM MANAGEMENT SPATIAL PREDICTION

(71) Applicant: Apple Inc., Cupertino, CA (US)

(72) Inventors: Konstantinos SARRIGEORGIDIS, Los Gatos, CA (US); Yang TANG, San Jose, CA (US); Manasa RAGHAVAN, Sunnyvale, CA (US); Jie CUI, San Jose, CA (US); Xiang CHEN, Campbell, CA (US)

(21) Appl. No.: 18/789,491

(22) Filed: Jul. 30, 2024

(51) Int. Cl. H04B 7/06; H04B 17/318; H04W 24/02

(52) U.S. Cl. CPC H04B 7/0696; H04B 17/328; H04W 24/02

(57) ABSTRACT

Described herein are solutions for dynamic model management and post-deployment verification for beam management spatial prediction. A user equipment (UE) can receive multiple artificial intelligence (AI)/machine learning (ML) models from an over-the-air (OTA) server. UE can deploy, monitor, and evaluate active and inactive AI/ML models according to one or more key performance indicators (KPIs). Examples of the KPIs can include input data and conditions associated with the AI/ML model, a distribution of output data produced by the AI/ML model, and an inference accuracy of the AI/ML model. UE 210 can determine that an AI/ML model is verified when KPIs are satisfied. These and many other features and examples are described herein.

### FIELD

This disclosure relates to wireless communication networks and mobile device capabilities.

### BACKGROUND

Wireless communication networks and wireless communication services are becoming increasingly dynamic, complex, and ubiquitous. For example, some wireless communication networks can be developed to implement fifth generation (5G) or new radio (NR) technology, sixth generation (6G) technology, and so on. Such technology can include solutions for enabling user equipment (UE) and network devices, such as base stations, to communicate with one another. A feature of such networks and devices can include managing and evaluating wireless signals.

### BRIEF DESCRIPTION OF THE DRAWINGS

The present disclosure will be readily understood and enabled by the detailed description and accompanying figures of the drawings. Like reference numerals can designate like features and structural elements. Figures and corresponding descriptions are provided as non-limiting examples of aspects, implementations, etc., of the present disclosure, and references to “an” or “one” aspect, implementation, etc., may not necessarily refer to the same aspect, implementation, etc., and can mean at least one, one or more, etc.

FIG. 1 is a diagram of an example overview of one or more of the techniques described herein.

FIG. 2 is a diagram of an example network according to one or more implementations described herein.

FIG. 3 is a diagram of an example of artificial intelligence (AI)/machine learning (ML) functions according to one or more implementations described herein.

FIG. 4 is a diagram of an example of AI/ML model according to one or more implementations described herein.

FIG. 5 is a diagram of an example of a process for dynamic model management and post-deployment verification according to one or more implementations described herein.

FIG. 6 is a diagram of an example of dynamically managed AI/ML models according to one or more implementations described herein.

FIG. 7 is a diagram of an example of a process of receiving, monitoring, and reporting performance results for AI/ML models according to one or more implementations described herein.

FIG. 8 is a diagram of example of attributes associated with an AI/ML model according to one or more implementations described herein.

FIG. 9 is a diagram of example process for dynamic model management and post-deployment verification for beam management and spatial predication according to one or more implementations described herein.

FIG. 10 is a diagram of an example of key performance indicators (KPIs) for dynamic model management and post-deployment verification for beam management and spatial predication according to one or more implementations described herein.

FIG. 11 is a diagram of an example of components of a device according to one or more implementations described herein.

FIG. 12 is a diagram of example interfaces of baseband circuitry according to one or more implementations described herein.

FIG. 13 is a block diagram illustrating components, according to one or more implementations described herein, able to read instructions from a machine-readable or computer-readable medium (e.g., a non-transitory machine-readable storage medium) and perform any one or more of the methodologies discussed herein.

FIG. 14 is a diagram of an example process for dynamic AI/ML model management and post-deployment verification according to one or more implementations described herein.

FIG. 15 is a diagram of an example process for dynamic AI/ML model management and post-deployment verification according to one or more implementations described herein.

### DETAILED DESCRIPTION

The following detailed description refers to the accompanying drawings. Like reference numbers in different drawings can identify the same or similar features, elements, operations, etc. Additionally, the present disclosure is not limited to the following description as other implementations can be utilized, and structural or logical changes made, without departing from the scope of the present disclosure.

Wireless communication networks can include user equipment (UE) capable of communicating with base stations and/or other network access nodes. The base stations can provide a UE with access to a core network (CN) and additional external networks, such as the Internet. Wireless communication networks can implement various techniques and standards that enable services to be provided to UEs in a consistent and high-quality manner. An example of such services can include ensuring that signaling, channels, connections, beams, and communications between a UE and the network maintain a desired level of quality, reliantly, and energy efficiency.

Beam management is a technique mainly used to optimize the alignment of highly directional transmission (Tx) and reception (Rx) beams. Beam management can be particularly helpful with respect to millimeter-wave (mmWave) communications. The technique can include processes, such as beamforming, beam selection, beam switching, and beam tracking. Such techniques can help maintain high-quality communication links despite challenges like path loss, blockages, and rapid changes in UE position and orientation. Beam selection can include a process by which quality beams are identified. A base station can sweep a transmit Tx beams according to a beam pattern, and a UE can sweep an Rx beam and select a best beam pair (Tx beam and Rx beam) as measured by the UE. The UE can report the beam to the base station. Additional beam management procedures can follow such as beam refinement of the beam pair.

Tools for enhancing the performance of wireless communication networks can include artificial intelligence (AI), machine learning (ML), deep learning (DL), neural networks (NNs), and similar technologies. For example, an AI model, ML model, DL model, NN model, etc., can be developed and applied to one or more devices or aspects of a network to enhance performance by recognizing patterns, interpreting circumstances, generating inferences, and so on. For conciseness, references herein to AI/ML, AI/ML model, model, etc., shall be interpreted broadly to include AI, ML, DL, NN, and similar technologies, including to any combination thereof.

An AI/ML model can be described as a logical framework of interrelated nodes developed to interpret or generate an inference about a corresponding set of inputs. The model can evaluate the inputs according to a combination of nodes that have been assigned different weights and relationships as the result of applying training data to improve and refine the AI/ML model. Conformance testing can include a technique used for developing an AI/ML model to be verified or validated for one or more scenarios, which can be characterized as conditions under which the AI/ML model can produce an inference output of suitable accuracy. While conformance testing can validate an AI/ML model for certain scenarios, the number of scenarios for which an AI/ML model can be validated using conformance testing is limited by practical constraints, such as time, energy, training data, the level of detail used to define a scenario, the number of possible scenarios, and more.

Currently available techniques for using AI/ML models in wireless communication network are deficient in several ways. For example, conformance testing is a relatively weak form of AI/ML model validation or verification because the highly mobile and technologically complex nature of such networks gives rise to both a tremendous number of possible scenarios that often change as devices move about the network. Additionally, when the performance of a deployed AI/ML model begins to degrade due to a change in scenarios, actions are not taken to remedy the situation until failure has been detected. Further, there are no adequate solutions for determining whether a new AI/ML model used to replace a failed AI/ML model will operate properly or for how long. And even when conformance testing is used to update a failed AI/ML model, the limits of conformance testing provide little guarantee that the updated AI/ML model will be a worthwhile improvement given the spectrum of possible real-world operating conditions.

One or more of the techniques described herein address these deficiencies by providing AI/ML model management solutions that involve proactive performance monitoring and post-deployment verification. AI/ML models and supporting functions can be applied to beam management, beam selection, beam refinement, and more. These and other procedures can be enhanced by AI/ML models and supporting functions by accurately predicting which Tx/Rx beam pairs between a UE and a base station will have the highest signal quality.

A UE can use AI/ML models to a predict reference signal received power (RSRP) and perform special prediction for Tx/Rx beams pairs, based on a pattern of pilot or probing Tx beams from a base station. The AI/ML models can produce a top number (K) of beam pairs based on a full map of RSRP values for all beam pairs. The base station can transmit beams according to the top K beam pairs, and UE can measure the actual RSRPs for the beam pairs. The UE can determine which AI/ML models accurately predict RSRPs by comparing the predicted RSRPs to the actual RSRPs. Determining accurate AI/ML models can enable the UE to perform beam management activities with greater efficiency by enabling the UE to reliably predict and identify beam pairs of the highest quality.

Additionally, the techniques described herein enable the performance of AI/ML models to be evaluated on actual UE hardware and in real-world conditions, thereby producing performance metrics and feedback that is superior in quantity and quality than conformance testing and similar methodologies. The performance testing can involve different types of key performance indicators (KPIs) to ensure AI/ML models are monitored under acceptable conditions, receive suitable input data, produce non-anomalous inference outputs, and are evaluated relative to non-AI/ML procedures performed, which can all be done using the same device and under the same conditions. By monitoring and evaluating AI/ML models proactively, declines in the performance of active AI/ML models can be detected and switched for more suitable AI/ML models prior to failure. Additionally, performance scores, feedback, and other performance related information can be used to update the conditions for which AI/ML models are valid, produce better AI/ML models, and more. These and many other features and examples are discussed below.

An AI/ML model can be viewed as software components that can be substituted, upgraded, and so on, and then executed on the same hardware in the device. When an AI/ML model is deployed to a device (e.g., a UE), a conformance test can be performed to ensure that the hardware of the device is adequate to implement the AI/ML model in the manner intended. Over time, the AI/ML model can be modified and retrained to create new versions of the AI/ML model. While such changes can improve the AI/ML model on a theoretical level, a question remains whether devices running a prior version of the AI/ML model are able to pass a conformance test on the newer version of the AI/ML model. For example, a newer version of an AI/ML model may not operate as intended on a device implementing a prior version of the AI/ML model. Additionally, the newer AI/ML model might operate better in some ways or under some conditions but worse in other ways or conditions. As such, it is beneficial to have a mechanism to ensure that an updated AI/ML model will operate properly before deploying the updated AI/ML model to the device implemented the prior version of the AI/ML model.

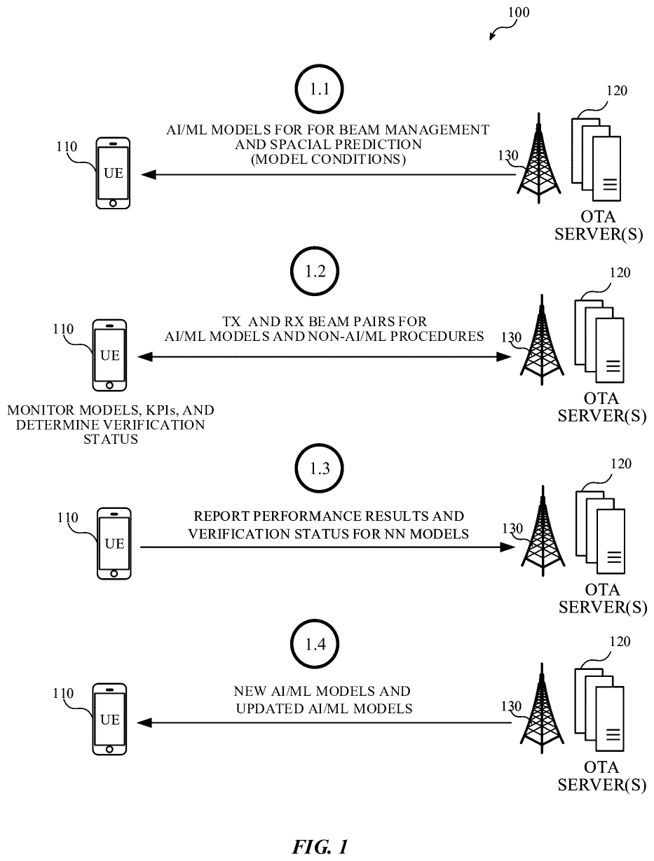

FIG. 1 is a diagram of an example overview 100 of one or more of the implementations described herein. As shown, example overview 100 can include UE 110, over-the-air (OTA) servers 120, and base station 130. OTA servers 120 can send multiple AI/ML models to UE 110 (at 1.1). UE 110 can deploy and monitor active and inactive AI/ML models, determine KPIs for the monitored AI/ML models, and designate AI/ML models as valid or invalid (at 1.2). UE 110 can do so based on a comparison of predicted and actual measurements derived from a Tx and Rx beam pairs for the AI/ML models and a corresponding non-AI/ML procedure.

UE 110 can deploy AI/ML models based on whether conditions associated with the AI/ML models are satisfied. The conditions can include a signal-to-noise ratio (SNR), a measured doppler value, a delay spread, signal interference levels, and more. The KPIs can include AI/ML model conditions being satisfied, a distribution of an output inference of an AI/ML model lacking anomalies, and a determination that the AI/ML model has an acceptable inference accuracy. UE 110 can designate an AI/ML model as verified (e.g., functioning properly) based on the KPIs.

UE 110 can report the performance results (e.g., KPIs) and verification status of the AI/ML models to OTA servers 120 and/or base station 130 (at 1.3). OTA servers 120 can create new AI/ML models and updated AI/ML models and send the models to UE 110 (at 1.4). In some implementations, the new AI/ML models and updated AI/ML models can be based on the performance results and verification statuses reported to OTA servers 120. While not shown, UE 110 can receive the new and updated AI/ML models and proceed to deploy, monitor, and determine the verification statuses of the AI/ML models base on KPIs. Additional examples of these and many other techniques, features, and implementations are described below with reference to the figures that follow.

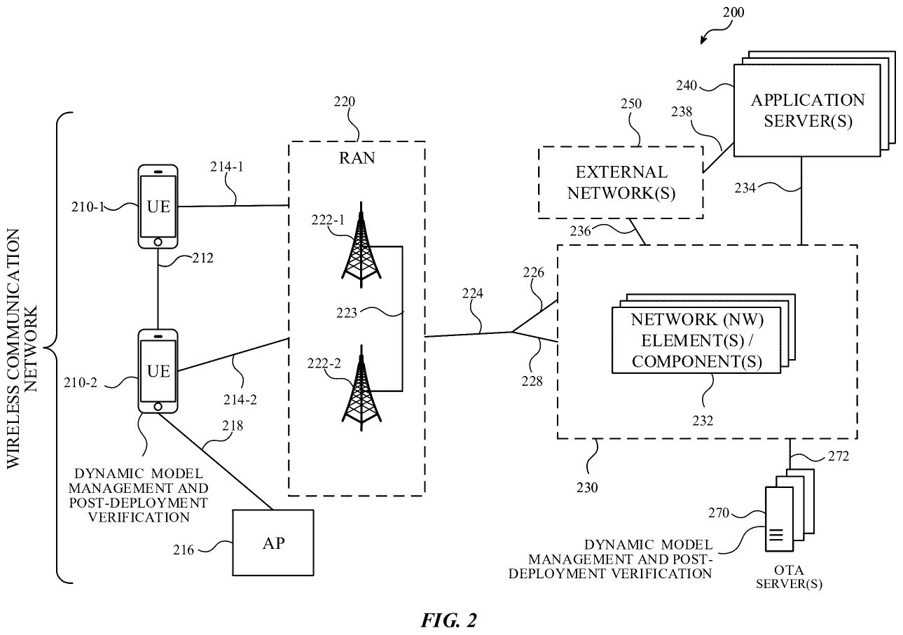

FIG. 2 is an example network 200 according to one or more implementations described herein. Example network 200 can include UEs 210, 210-2, etc. (referred to collectively as “UEs 210” and individually as “UE 210”), a radio access network (RAN) 220, a core network (CN) 230, application servers 240, and external networks 250.

The systems and devices of example network 200 can operate in accordance with one or more communication standards, such as 2nd generation (2G), 3rd generation (3G), 4th generation (4G) (e.g., long-term evolution (LTE)), and/or 5th generation (5G) (e.g., new radio (NR)) communication standards of the 3rd generation partnership project (3GPP). Additionally, or alternatively, one or more of the systems and devices of example network 200 can operate in accordance with other communication standards and protocols discussed herein, including future versions or generations of 3GPP standards (e.g., sixth generation (6G) standards, seventh generation (7G) standards, etc.), institute of electrical and electronics engineers (IEEE) standards (e.g., wireless metropolitan area network (WMAN), worldwide interoperability for microwave access (WiMAX), etc.), and more.

As shown, UEs 210 can include smartphones (e.g., handheld touchscreen mobile computing devices connectable to one or more wireless communication networks). Additionally, or alternatively, UEs 210 can include other types of mobile or non-mobile computing devices capable of wireless communications, such as personal data assistants (PDAs), pagers, laptop computers, desktop computers, wireless handsets, etc. In some implementations, UEs 210 can include internet of things (IoT) devices (or IoT UEs) that can comprise a network access layer designed for low-power IoT applications utilizing short-lived UE connections. Additionally, or alternatively, an IoT UE can utilize one or more types of technologies, such as machine-to-machine (M2M) communications or machine-type communications (MTC) (e.g., to exchanging data with an MTC server or other device via a public land mobile network (PLMN)), proximity-based service (ProSc) or device-to-device (D2D) communications, sensor networks, IoT networks, and more. Depending on the scenario, an M2M or MTC exchange of data can be a machine-initiated exchange, and an IoT network can include interconnecting IoT UEs (which can include uniquely identifiable embedded computing devices within an Internet infrastructure) with short-lived connections. In some scenarios, IoT UEs can execute background applications (e.g., keep-alive messages, status updates, etc.) to facilitate the connections of the IoT network. UEs 210 can communicate and establish a connection with one or more other UEs 210 via one or more wireless channels 212, each of which can comprise a physical communications interface/layer. The connection can include an M2M connection, MTC connection, D2D connection, SL connection, etc. The connection can involve a PC5 interface. In some implementations, UEs 210 can be configured to discover one another, negotiate wireless resources between one another, and establish connections between one another, without intervention or communications involving RAN node 222 or another type of network node. In some implementations, discovery, authentication, resource negotiation, registration, etc., can involve communications with RAN node 222 or another type of network node.

UEs 210 can use one or more wireless channels 212 to communicate with one another. As described herein, UE 210 can communicate with RAN node 222 to request SL resources. RAN node 222 can respond to the request by providing UE 210 with a dynamic grant (DG) or configured grant (CG) regarding SL resources. A DG can involve a grant based on a grant request from UE 210. A CG can involve a resource grant without a grant request and can be based on a type of service being provided (e.g., services that have strict timing or latency requirements). UE 210 can perform a clear channel assessment (CCA) procedure based on the DG or CG, select SL resources based on the CCA procedure and the DG or CG; and communicate with another UE 210 based on the SL resources. The UE 210 can communicate with RAN node 222 using a licensed frequency band and communicate with the other UE 210 using an unlicensed frequency band.

UEs 210 can communicate and establish a connection with (e.g., be communicatively coupled) with RAN 220, which can involve one or more wireless channels 214-1 and 214-2, each of which can comprise a physical communications interface/layer. In some implementations, a UE can be configured with dual connectivity (DC) as a multi-radio access technology (multi-RAT) or multi-radio dual connectivity (MR-DC), where a multiple receive and transmit (Rx/Tx) capable UE can use resources provided by different RAN network nodes (e.g., RAN network nodes 222-1 and 222-2) that can be connected via non-ideal backhaul (e.g., where one network node provides NR access and the other network node provides either E-UTRA for LTE or NR access for 5G). In such a scenario, one network node can operate as a master node (MN) and the other as the secondary node (SN). The MN and SN can be connected via a network interface, and at least the MN can be connected to the CN 230. Additionally, at least one of the MN or the SN can be operated with shared spectrum channel access, and functions specified for UE 210 can be used for an integrated access and backhaul mobile termination (IAB-MT). Similar for UE 210, the IAB-MT can access the network using either one network node or using two different nodes with enhanced dual connectivity (EN-DC) architectures, new radio dual connectivity (NR-DC) architectures, or the like. In some implementations, a base station (as described herein) can be an example of network RAN network nodes.

As shown, UE 210 can also, or alternatively, connect to access point (AP) 216 via connection interface 218, which can include an air interface enabling UE 210 to communicatively couple with AP 216. AP 216 can comprise a wireless local area network (WLAN), WLAN node, WLAN termination point, etc. The connection 216 can comprise a local wireless connection, such as a connection consistent with any IEEE 702.11 protocol, and AP 216 can comprise a wireless fidelity (Wi-Fi®) router or other AP. While not explicitly depicted in FIG. 2, AP 216 can be connected to another network (e.g., the Internet) without connecting to RAN 220 or CN 230. In some scenarios, UE 210, RAN 220, and AP 216 can be configured to utilize LTE-WLAN aggregation (LWA) techniques or LTE WLAN radio level integration with IPsec tunnel (LWIP) techniques. LWA can involve UE 210 in RRC_CONNECTED being configured by RAN 220 to utilize radio resources of LTE and WLAN. LWIP can involve UE 210 using WLAN radio resources (e.g., connection interface 218) via IPsec protocol tunneling to authenticate and encrypt packets (e.g., Internet Protocol (IP) packets) communicated via connection interface 218. IPsec tunneling can include encapsulating the entirety of original IP packets and adding a new packet header, thereby protecting the original header of the IP packets.

RAN 220 can include one or more RAN nodes 222-1 and 222-2 (referred to collectively as RAN nodes 222, and individually as RAN node 222) that enable channels 214-1 and 214-2 to be established between UEs 210 and RAN 220. RAN nodes 222 can include network access points configured to provide radio baseband functions for data and/or voice connectivity between users and the network based on one or more of the communication technologies described herein (e.g., 2G, 3G, 4G, 5G, WiFi®, etc.). As examples therefore, a RAN node can be an E-UTRAN Node B (e.g., an enhanced Node B, eNodeB, eNB, 4G base station, etc.), a next generation base station (e.g., a 5G base station, NR base station, next generation eNBs (gNB), etc.). RAN nodes 222 can include a roadside unit (RSU), a transmission reception point (TRxP or TRP), and one or more other types of ground stations (e.g., terrestrial access points). In some scenarios, RAN node 222 can be a dedicated physical device, such as a macrocell base station, and/or a low power (LP) base station for providing femtocells, picocells or the like having smaller coverage areas, smaller user capacity, or higher bandwidth compared to macrocells.

Some or all of RAN nodes 222, or portions thereof, can be implemented as one or more software entities running on server computers as part of a virtual network, which can be referred to as a centralized RAN (CRAN) and/or a virtual baseband unit pool (vBBUP). In these implementations, the CRAN or vBBUP can implement a RAN function split, such as a packet data convergence protocol (PDCP) split wherein radio resource control (RRC) and PDCP layers can be operated by the CRAN/vBBUP and other Layer 2 (L2) protocol entities can be operated by individual RAN nodes 222; a media access control (MAC)/physical (PHY) layer split wherein RRC, PDCP, radio link control (RLC), and MAC layers can be operated by the CRAN/vBBUP and the PHY layer can be operated by individual RAN nodes 222; or a “lower PHY” split wherein RRC, PDCP, RLC, MAC layers and upper portions of the PHY layer can be operated by the CRAN/vBBUP and lower portions of the PHY layer can be operated by individual RAN nodes 222. This virtualized framework can allow freed-up processor cores of RAN nodes 222 to perform or execute other virtualized applications.

In some implementations, an individual RAN node 222 can represent individual gNB-distributed units (DUs) connected to a gNB-control unit (CU) via individual F1 or other interfaces. In such implementations, the gNB-DUs can include one or more remote radio heads or radio frequency (RF) front end modules (RFEMs), and the gNB-CU can be operated by a server (not shown) located in RAN 220 or by a server pool (e.g., a group of servers configured to share resources) in a similar manner as the CRAN/vBBUP. Additionally, or alternatively, one or more of RAN nodes 222 can be next generation eNBs (i.e., gNBs) that can provide evolved universal terrestrial radio access (E-UTRA) user plane and control plane protocol terminations toward UEs 210, and that can be connected to a 5G core network (5GC) 230 via an NG interface.

Any of the RAN nodes 222 can terminate an air interface protocol and can be the first point of contact for UEs 210. In some implementations, any of the RAN nodes 222 can fulfill various logical functions for the RAN 220 including, but not limited to, radio network controller (RNC) functions such as radio bearer management, uplink and downlink dynamic radio resource management and data packet scheduling, and mobility management. UEs 210 can be configured to communicate using orthogonal frequency-division multiplexing (OFDM) communication signals with each other or with any of the RAN nodes 222 over a multicarrier communication channel in accordance with various communication techniques, such as, but not limited to, an OFDMA communication technique (e.g., for downlink communications) or a single carrier frequency-division multiple access (SC-FDMA) communication technique (e.g., for uplink and ProSe or sidelink (SL) communications), although the scope of such implementations may not be limited in this regard. The OFDM signals can comprise a plurality of orthogonal subcarriers.

In some implementations, a downlink resource grid can be used for downlink transmissions from any of the RAN nodes 222 to UEs 210, and uplink transmissions can utilize similar techniques. The grid can be a time-frequency grid (e.g., a resource grid or time-frequency resource grid) that represents the physical resource for downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises resource blocks, which describe the mapping of certain physical channels to resource elements. Each resource block can comprise a collection of resource elements (REs); in the frequency domain, this can represent the smallest quantity of resources that currently can be allocated. There are several different physical downlink channels that are conveyed using such resource blocks.

Further, RAN nodes 222 can be configured to wirelessly communicate with UEs 210, and/or one another, over a licensed medium (also referred to as the “licensed spectrum” and/or the “licensed band”), an unlicensed shared medium (also referred to as the “unlicensed spectrum” and/or the “unlicensed band”), or combination thereof. A licensed spectrum can correspond to channels or frequency bands selected, reserved, regulated, etc., for certain types of wireless activity (e.g., wireless telecommunication network activity), whereas an unlicensed spectrum can correspond to one or more frequency bands that are not restricted for certain types of wireless activity. Whether a particular frequency band corresponds to a licensed medium or an unlicensed medium can depend on one or more factors, such as frequency allocations determined by a public-sector organization (e.g., a government agency, regulatory body, etc.) or frequency allocations determined by a private-sector organization involved in developing wireless communication standards and protocols, etc.

To operate in the unlicensed spectrum, UEs 210 and the RAN nodes 222 can operate using stand-alone unlicensed operation, licensed assisted access (LAA), eLAA, and/or feLAA mechanisms. In these implementations, UEs 210 and the RAN nodes 222 can perform one or more known medium-sensing operations or carrier-sensing operations in order to determine whether one or more channels in the unlicensed spectrum is unavailable or otherwise occupied prior to transmitting in the unlicensed spectrum. The medium/carrier sensing operations can be performed according to a listen-before-talk (LBT) protocol.

The PDSCH can carry user data and higher layer signaling to UEs 210. The physical downlink control channel (PDCCH) can carry information about the transport format and resource allocations related to the PDSCH channel, among other things. The PDCCH can also inform UEs 210 about the transport format, resource allocation, and hybrid automatic repeat request (HARQ) information related to the uplink shared channel. Typically, downlink scheduling (e.g., assigning control and shared channel resource blocks to UE 210 within a cell) can be performed at any of the RAN nodes 222 based on channel quality information fed back from any of UEs 210. The downlink resource assignment information can be sent on the PDCCH used for (e.g., assigned to) each of UEs 210.

The RAN nodes 222 can be configured to communicate with one another via interface 223. In implementations where the system is an LTE system, interface 223 can be an X2 interface. In NR systems, interface 223 can be an Xn interface. The X2 interface can be defined between two or more RAN nodes 222 (e.g., two or more eNBs/gNBs or a combination thereof) that connect to evolved packet core (EPC) or CN 230, or between two eNBs connecting to an EPC. In some implementations, the X2 interface can include an X2 user plane interface (X2-U) and an X2 control plane interface (X2-C).

The X2-U can provide flow control mechanisms for user data packets transferred over the X2 interface and can be used to communicate information about the delivery of user data between eNBs or gNBs. For example, the X2-U can provide specific sequence number information for user data transferred from a master eNB (MeNB) to a secondary eNB (SeNB); information about successful in sequence delivery of PDCP packet data units (PDUs) to a UE 210 from an SeNB for user data; information of PDCP PDUs that were not delivered to a UE 210; information about a current minimum desired buffer size at the SeNB for transmitting to the UE user data; and the like. The X2-C can provide intra-LTE access mobility functionality (e.g., including context transfers from source to target eNBs, user plane transport control, etc.), load management functionality, and inter-cell interference coordination functionality.

As shown, RAN 220 can be connected (e.g., communicatively coupled) to CN 230. RAN 220 communicate with CN 230 via interfaces 224, 226, and/or 228. CN 230 can comprise a plurality of network elements 232, which are configured to offer various data and telecommunications services to customers/subscribers (e.g., users of UEs 210) who are connected to the CN 230 via the RAN 220. In some implementations, CN 230 can include an evolved packet core (EPC), a 5G CN, and/or one or more additional or alternative types of CNs. The components of the CN 230 can be implemented in one physical node, or separate physical nodes including components to read and execute instructions from a machine-readable or computer-readable medium (e.g., a non-transitory machine-readable storage medium). In some implementations, network function virtualization (NFV) can be utilized to virtualize any or all the above-described network node roles or functions via executable instructions stored in one or more computer-readable storage mediums (described in further detail below). A logical instantiation of the CN 230 can be referred to as a network slice, and a logical instantiation of a portion of the CN 230 can be referred to as a network sub-slice. Network Function Virtualization (NFV) architectures and infrastructures can be used to virtualize one or more network functions, alternatively performed by proprietary hardware, onto physical resources comprising a combination of industry-standard server hardware, storage hardware, or switches. In other words, NFV systems can be used to execute virtual or reconfigurable implementations of one or more EPC components/functions.

As shown, CN 230, application servers 240, and external networks 250 can be connected to one another via interfaces 234, 236, and 238, which can include IP network interfaces. Application servers 240 can include one or more server devices or network elements (e.g., virtual network functions (VNFs) offering applications that use IP bearer resources with CM 230 (e.g., universal mobile telecommunications system packet services (UMTS PS) domain, LTE PS data services, etc.). Application servers 240 can also, or alternatively, be configured to support one or more communication services (e.g., voice over IP (VOIP) sessions, push-to-talk (PTT) sessions, group communication sessions, social networking services, etc.) for UEs 210 via the CN 230. Similarly, external networks 250 can include one or more of a variety of networks, including the Internet, thereby providing the mobile communication network and UEs 210 of the network access to a variety of additional services, information, interconnectivity, and other network features.

OTA servers 270 can include on or more server or server device capable of receiving, processing, storing, and communicating information. OTA servers 270 can communicate with CN 230 via interface 272. OTA servers 270 can be implemented as a cloud of server devices, one or mor e virtual devices, or a combination thereof. OTA servers 270 can provide one or more types of OTA services. Examples of such services can creating virtual wireless environments and testing wireless devices, including components, configurations, software, and conditions relative to wireless devices, within the wireless environments. OTA servers 270 can receive, generate, train, retrain, update, modify, store, test, and/or distribute one or more types of AI/ML models. Additionally, OTA servers 270 can test, monitor, measure, and evaluate performance of AI/ML models in such environments. In some implementations, OTA servers 270 can instead be implemented as one or more application servers or one or more other types of server devices. In some implementations, functionality described herein as being provided by OTA servers 270 can be provided by another device (e.g., one or more functions of CN 230) or by a combination of combination another device and OAT servers 270.

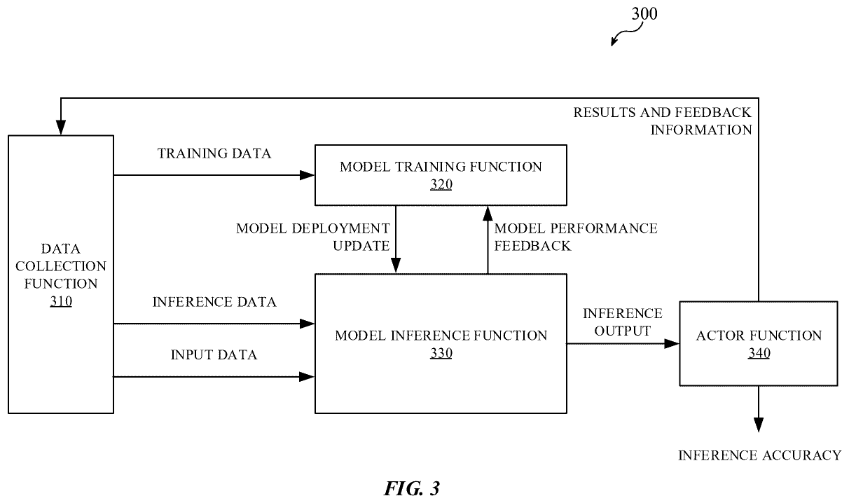

FIG. 3 is a diagram of an example of AI/ML functions 300 according to one or more implementations described herein. As shown, example 300 can include data collection function 310, model training function 320, model inference function 330, and actor function 340. In some implementations, AI/ML functions 300 can include one or more, fewer, alternative, or alternatively arranged functions than those depicted. Aspects of AI/ML functions 300 can be implemented by one or more devices, such as UE 210, base station 222, network elements of CN 230, OTA servers 270, or a combination thereof. For example, OTA servers 270 can implement aspects of AI/ML functions 300 to generate, train, test, and evaluate AI/ML models. The AI/ML models can be distributed to UE 210, and UE can implement one or more aspects of AI/ML functions 300 for AI/ML model deployment, evaluation, and feedback generation. OTA servers 270 can implement aspects of AI/ML model functionality to update AI/ML models, retrain AI/ML models, and send modified versions of AI/ML models to UE 210. The AI/ML models can be configured and trained to operate under specified conditions and generate certain types of inferences relating to UE 210, base station 222, and/or communications between UE 210 and base station 222.

Data collection function 310 can provide input data to model training function 320 and model inference function 330. Examples of input data can include measurements from UEs 210 or different network entities, feedback from actor function 340, output from an AI/ML model. As described herein, an AI/ML model can include a framework of functions, vectors, and/or other types of features that have been trained by applying training data to the AI/ML model. The AI/ML model can be capable of evaluating input data and producing output data interpreted as an inference derived from input data applied to the AI/ML model.

Training data can include input data for the AI/ML model training function 320. Model training function 320 can perform AI/ML model training, validation, and testing which can generate model performance metrics as part of a model testing procedure. Model training function 320 can also be responsible for data preparation (e.g., data pre-processing and cleaning, formatting, and transformation) based on training data delivered by a data collection function 310. A model deployment/update can be used to initially deploy a trained, validated, and tested AI/ML model to model inference function 330 or to deliver an updated model to model inference function 330.

Model inference function 330 can implement an AI/ML model to produce an inference output based on input data provided to model inference function 330. The input data can be provided by a device executing data collection function, which can be the same or a different device performing model inference function 330. Model inference function 330 can also perform for data preparation procedures (e.g., data pre-processing, cleaning, formatting, and transformation) based on inference data provided by data collection function 310. Model inference function 330 can generate and provide model performance feedback to model training function 320 when applicable. The model performance feedback can be used evaluate the performance of an AI/ML model, which can lead to the AI/ML model being updated and/or retrained depending on an accuracy of the output inference.

Actor function 340 can receive an inference output from the model inference function 330 and perform one or more procedures using the inference output. Actor function 340 can include a function configured to use or evaluate the inference output of model inference function 330 in one or more ways. For example, input data provided to model inference function 330 can also be provided to a non-NN procedure. Model inference function 330 can produce an inference output intended to predict or anticipate the output produced by the non-NN procedure. Actor function 340 can perform the non-NN procedure, using the same input data used by model inference function 330, to produce output data of the non-NN procedures.

Actor function 340 can apply one or more data processing, evaluation, and analysis functions or tools to the inference output and/or the output of the non-NN procedure to determine an inference accuracy of the AI/ML model (e.g., whether the AI/ML model accurately predicted the output of the non-NN procedure). Actor function 340 can also determine whether one or more additional inputs or conditions are appropriate for using the AI/ML model based on an inference accuracy of the interference output. Actor function 340 can produce results, feedback, and other information that can be used to derive training data, inference data, or monitor the performance of the AI/ML model and its impact on one or more device, such as UE 210, base station 222, etc.

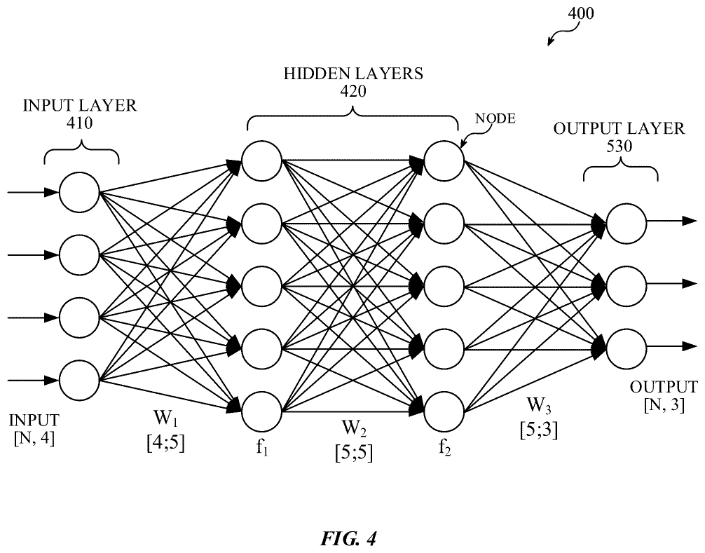

FIG. 4 is a diagram of an example of AI/ML model 400 according to one or more implementations described herein. As shown, AI/ML model 400 can include nodes arranged in different layers, such as an input layer 410, multiple hidden or intermediary layers 420 of nodes, and an output layer 430 of nodes. In some implementations, AI/ML model 400 can be an example of, or a portion of, model training function 420, an AI/ML model, model inference function 430, and/or actor function 440. For example, AI/ML model 400 can be trained on training data from data collection function 410, deployed by model training function 420 as an AI/ML model, and used by model inference function 430 to produce feedback for model training function 420 and an inference output for actor function 440.

Example AI/ML model 400 can include a number N of inputs introduced to four input nodes [N, 4] of input layer 410. This can include processing or encoding input data into a form, shape, vector, or data structure, that is receivable by the AI/ML model. The four input nodes can process the inputs to produce a first weight (W₁) that the four input nodes provide to the five nodes [4; 4] of a first hidden layer. The five nodes of the first hidden layer can use a first function (f₁) to process the inputs to produce a second weight (W₂) that the five nodes of the first hidden layer can provide to the five nodes [4; 4] of a second hidden layer. The five nodes of the second layer can use a second function (f₂) to process the inputs to produce a third weight (W₃) that the five nodes of the second hidden layer can provide to the three nodes [4; 3] of output layer 430. The nodes of output layer 430 can each process the inputs received and produce an output. This can include converting or unencoding output data from a form, shape, vector, or data structure, that can be used by a subsequent algorithm, process, or procedure.

One or more of the techniques described herein as using a NN, an AI/ML model, and the like, can be implemented using any type or combination of artificial intelligence (AI). Generally, AI can involve a combination of computer science and datasets to enable problem-solving. AI can encompass machine learning (ML) and deep learning (DL). These disciplines are comprised of AI algorithms that seek to create expert systems which make predictions or classifications based on input data. ML, DL, and neural networks (NNs) can be viewed as sub-fields of AI. However, NNs can actually be a sub-field of ML, and DL can be a sub-field of NNs. The way in which DL and ML differ can include in how each algorithm learns. Deep ML can use labeled datasets (also known as supervised learning) to inform its algorithm but may not necessarily involve a labeled dataset. DL can ingest unstructured data in a raw form (e.g., text or images) and can automatically or autonomously determine the set of features that distinguish different categories of data from one another. This can eliminate some of the human intervention otherwise involved and enable use of larger data sets. DL can be viewed, in a sense, as scalable ML.

NNs, or artificial NNs (ANNs), can comprise logically interconnected nodes arranged in node layers. There can be an input layer, one or more hidden or intermediate layers, and an output layer. Each node, or artificial neuron, can connect to another and has an associated weight and threshold. If the output of any individual node is above the specified threshold value, that node is activated, sending data to the next layer of the network. Otherwise, no data can be passed along to the next layer of the network by that node. The “deep” in deep learning can refer to the number of layers in an NN. An AI/ML model with more than three layers—which would be inclusive of the input and the output—can be considered a deep learning algorithm or a deep NN. A NN model with only three layers can be viewed as a basic NN.

A NN can be a feed forward NN (FNN) or a recurrent NN (RNN). Examples of a FFN can include linear functions, such as a convolutional NN (CNN) or a NN that uses a radial basis function network. A CNN can include a framework capable of discovering NN features using filter or kernel optimization and producing an output. These NNs can harness principles from linear algebra, particularly matrix multiplication, to identify patterns within an image. Linear regression analysis, for example, can be used to predict a value of a variable based on a value of another variable. This form of analysis can estimate coefficients of a linear equation, involving one or more independent variables that best predict the value of the dependent variable. Linear regression can fit a straight line or surface that minimizes discrepancies between a predicted value and an actual value. These learning algorithms can be leveraged when using time-series data to make predictions about future outcomes.

An NN using a radial basis function network can be a linear combination of radial basis functions of inputs and neuron parameters. Radial basis function networks can be used for function approximation, time series prediction, classification, and system control. An RNN can be a bi-directional (as opposed to a linear) NN. A RNN can allow the output from some nodes to affect a subsequent input to the same nodes, thus having feedback loops and the potential for infinite impulse response compared to the finite impulse response of the more linear CNN.

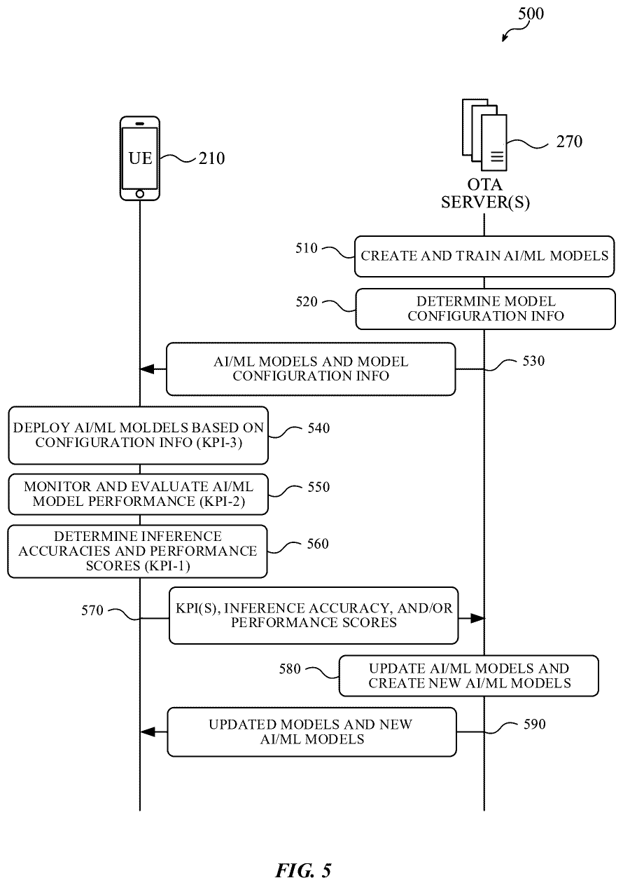

FIG. 5 is a diagram of an example of a process 500 for dynamic model management and post-deployment verification according to one or more implementations described herein. As shown, process 500 can be implemented by UE 210 and OTA servers 270. In some implementations, some or all of process 500 can be performed by one or more other systems or devices, including one or more of the devices of FIG. 2. For example, process 500 can be implemented by UE 210 and another type of server or an entity of CN 230 or one or more application servers 240. Additionally, process 500 can include one or more fewer, additional, differently ordered and/or arranged operations than those shown in FIG. 5. In some implementations, some or all of the operations of process 500 can be performed independently, successively, simultaneously, etc., of one or more of the other operations of process 500. As such, the techniques described herein are not limited to a number, sequence, arrangement, timing, etc., of the operations or processes depicted in FIG. 5.

As shown, process 500 can include OTA servers 270 creating and training AI/ML models (at 510). The AI/ML models can be configured for beam management spatial prediction. For example, the AI/ML models can generate an output inference of RSRP predictions. The input data can be based on measurements of Tx/Rx beam pairs. OTA servers 270 can train the AI/ML models by comparing the output inferences of the AI/ML models to measured RSRPs of corresponding Tx/Rx beam pairs. Using the same beam pairs can help ensure an accurate evaluation of the output inferences of the AI/ML models relative to the actual RSRPs of measured beam pairs. As such, the AI/ML models can be trained based on examples of beam pairs, measurements, and RSRPs.

Process 500 can include OTA servers 270 determining model configuration information (at 520). The model configuration information can correspond to the AI/ML models created and trained by OTA servers 270. Examples of model configuration information can including conditions for deploying the AI/ML models, acceptable data distributions of input data, acceptable data distributions of output data, tools and techniques for monitoring and evaluating the performance of the AI/ML models, and more. In some implementations, a unique model identifier (e.g., a model ID) can be associated with each AI/ML model and model configuration information corresponding thereto. The configuration information can include KPIs for deploying, monitoring and evaluating, and determining an inference accuracy of AI/ML models. Process 500 can include OTA servers 270 can send the AI/ML models and the model configuration information to UE 210 (at 530).

Process 500 can include UE 210 deploying one or more AI/ML models based on model configuration information (at 540). For example, UE 210 can determine a KPI (e.g., KPI-3) of one or more AI/ML models. KPI-3 can refer to whether current operating conditions of UE 210, characteristics of measured beam pairs, beam pairs of a set of beam pairs, etc., satisfy the conditions and input data associated with scenarios for which an AI/ML model has been created and trained. The input data can be one or more characteristics of a Tx pilot beam, Tx beam pattern, set of Tx beams, etc. UE 210 can deploy AI/ML models when KPI-3 is satisfied. AI/ML models can be deployed as active or inactive. An active AI/ML model can be an AI/ML model that is actually being used by UE 210 to generate an inference output (e.g., a predicted RSRP) that is actually used by UE 210 to facilitate communications between UE 210 and base station 222. An inactive AI/ML model can be an AI/ML model used to produce an inference output that can be evaluated by UE 210 but is not actually used to facilitate communications with base station 222.

Process 500 can include UE 210 monitoring and evaluating AI/ML model performance (at 550). For example, UE 210 can determine a KPI (e.g., KPI-2) of deployed AI/ML models. The AI/ML models can be active or inactive AI/ML models. KPI-2 can refer to a distribution of an inference output of an AI/ML model. UE 210 can determine whether the distribution of an inference output is consistent with distributions of accurate inference outputs (e.g., RSRPs). UE 210 can evaluate AI/ML model using one or more tools, such as support vector machine (SVM), UE 210 can determine whether the distribution of an AI/ML model includes an anomaly or another type of distributions that is indicative of the AI/ML model is not valid or configured for current operating conditions. When KPI-2 indicates that the AI/ML model is not valid, UE 210 can refrain from determining an inference accuracy of the AI/ML model.

Process 500 can include UE 210 determining inference accuracies and performance scores of AI/ML models (at 560). For example, UE 210 can determine a KPI (e.g., KPI-1) representing an inference accuracy and/or performance score of deployed AI/ML models. UE 210 can determine an inference accuracy based on a comparison of the inference output and a corresponding output of a non-AI/ML procedure. For example, the inference output can be a predicted RSRP for a beam pair and the output of the non-AI/ML procedure can be an actual or measured RSRP for the beam pair. In such a scenario, inference accuracy increases the more similar the inference output is to the measured RSRP. UE 210 can use one or more tools, such as squared generalized cosine similarity (SGCS), normalized mean squared error (NMSE), etc. UE 210 can determine a performance score to an AI/ML model based on KPIs resulting from deploying and monitoring the performance of the AI/ML model.

Process 500 can include UE 210 sending KPIs, inference accuracies, and/or performance scores to OTA servers 270 (at 570) and OTA servers 270 updating AI/ML models and creating new AI/ML models (at 580). OTA servers 270 can update existing AI/ML models and/or create new AI/ML models based on (or in response to) KPIs, inference accuracies, and/or performance scores. Process 500 can include OTA servers 270 sending the updated and/or create new AI/ML models to UE 210 (at 590). In some implementations, OTA servers 270 can send a model ID associated with new or additional attributes for an existing AI/ML model (e.g., new conditions associated with UE capabilities, conditions not associated with UE capabilities, etc. While not shown, UE 210 can deploy, monitor and evaluate the updated and new AI/ML models as described above. Accordingly, the techniques described herein provide solutions for dynamically updating dynamic model management and post-deployment verification for beam management spatial prediction.

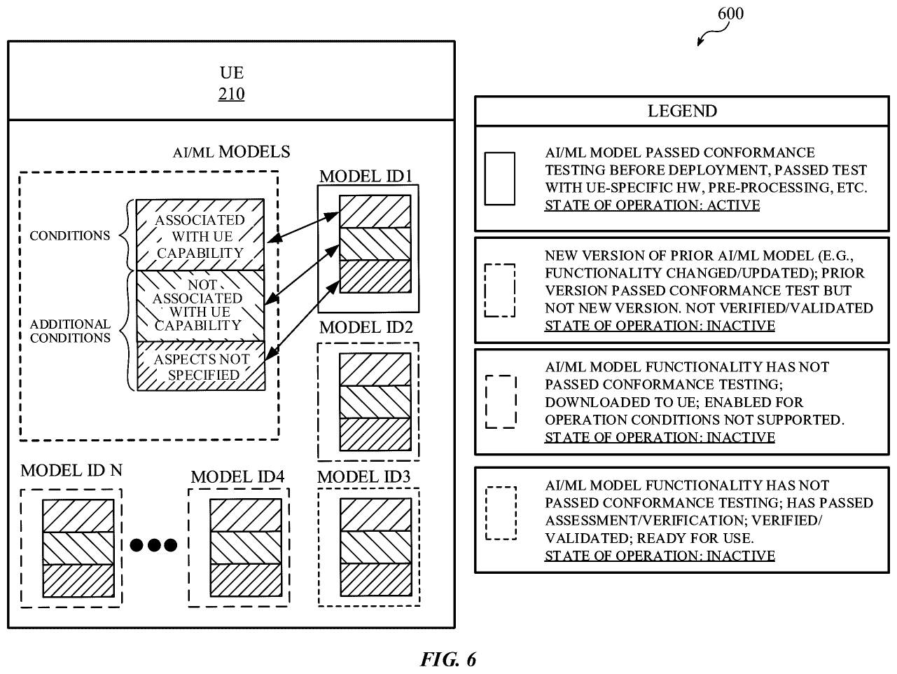

FIG. 6 is a diagram of an example 600 of dynamically managed AI/ML models according to one or more implementations described herein. As shown, UE 210 can store one or more AI/ML models. Each AI/ML model can be associated with one or more attributes, such as a unique model ID (e.g., model ID1), conditions, and additional conditions. In some implementations, a model ID can include attributes, such as the conditions, additional condition, etc., of a corresponding AI/ML model.

The AI/ML models of example 600 include model ID1, model ID2, model ID3, model ID4, . . . , and model IDN (where N is greater than or equal to 5). Each of the AI/ML models of example 600 can be associated with one or more conditions associated with UE capabilities and one or more additional conditions not associated with UE capabilities. Examples of such conditions can include a characteristic of a wireless channel used to enable UE 210 to communicate with base station 222, parameters or configurations associated with a network of a particular service provider, and so on. Additional examples of such conditions can include a measured SNR relative to a SNR threshold, a measured doppler value relative to a doppler threshold, a delay spread relative to a delay spread threshold, a measured level of signal interference relative to an interference threshold, and more. Additional conditions can also include aspects that are not specified, such as subsets of conditions, a beam pattern of one or more beam sets, a number of beams of one or more beam sets, a UE distribution, an urban macro (UMa) scenario, an urban micro (UMi) scenario, and more. Additional conditions can include a bandwidth associated with one or more beams, a beam shape, a beam angle, a Tx Rx unit (TXRU) mapping, an antenna layout configuration, an antenna spacing, and more.

The model ID can be associated with one or more sets of conditions or additional conditions, which can include different types of conditions and/or different condition thresholds or values. Conditions and/or additional conditions can be grouped or characterized as network (NW) side conditions or UE side conditions. NW side conditions can include conditions, scenarios, or configurations relating to a NW side of communications between base station 222 and UE 210. By contrast, UE side conditions can include conditions, scenarios, or configurations relating to a UE side of communications between base station 222 and UE 210. In some implementations, a condition or an additional condition can be grouped or characterized as a UE side, a NW side conditions, or both. In some implementations, the model ID of an AI/ML model can include conditions, additional conditions, and one or more additional attributes as described with reference to one or more subsequent Figures.

The AI/ML models of example 600 represent how UE 210 can receive multiple AI/ML models from OTA servers 270, test the AI/ML models locally, and dynamically change the states of the AI/ML models, thereby reflecting a continuous evolution and adaptation of AI/ML models at UE 210. As shown, the AI/ML model of model ID1 can correspond to status information A; the AI/ML model of model ID2 can correspond to status information B; the AI/ML model of model ID3 can correspond to status information C; and the AI/ML models of model ID4 through model IDN can correspond to status information D. The AI/ML models of example 600 can be in an active or inactive state, which can depend on factors such as whether the AI/ML model as passed certain tests, is a new version of a previous AI/ML model, and so on.

For example, the AI/ML model of model ID1 can be in an active state for having passed conformance testing (e.g., at OTA servers 270) and passed a performance test at UE 210. The performance test at UE 210 can include using the hardware of UE 210 to determine that the AI/ML model produces accurate inference outputs. The test at the UE 210 can also include a pre-processing test and/or one or other types of tests As such, the AI/ML model of model ID1 can be in an active state of operation, such that the AI/ML model is producing inference outputs used in actual UE operations.

The AI/ML model of model ID2 can be a new version of a prior AI/ML model. OTA servers 270 can update or retrain an AI/ML model to produce a new version of the AI/ML model, and the new version can be sent to UE 210. The new version of the AI/ML model can have different or updated functionality relative to the prior version. Even though the prior version of the AI/ML model passed conformance testing, the new version has not passed conformance testing and has not been verified or validated by UE 210. Verifying an AI/ML model can include testing, measuring, or otherwise evaluating or determining that an AI/ML model operates within acceptable performance parameters under conditions consisting with those for which the AI/ML model was designed and trained. Validating an AI/ML model can include a determination that the an AI/ML model generate output inferences of with an adequate threshold, level, or degree of accuracy and reliability. In some implementations, model verification, model validity, etc., can have the same meaning or similar meanings. The AI/ML model of model ID2 can therefore be in an inactive state. While inactive, UE 210 can still monitor, test, and evaluate the performance of the AI/ML model.

The AI/ML model of model ID3 has not passed conformance testing. The AI/ML model has been downloaded to UE 210 so that the AI/ML model can be operated and tested under additional condition (e.g., conditions not supported by UE 210). The AI/ML model of model ID3 is inactive and unverified. The AI/ML model of model ID4 has not passed conformance testing but has been downloaded to UE 210. UE 210 has assessed and verified the AI/ML model of model ID4. And even though the AI/ML model is in an inactive state, the AI/ML model has been verified by UE 210 and is ready for deployment (e.g., testing or activation at UE 210). Accordingly, UE 210 can receive and store multiple AI/ML models, each AI/ML model can by dynamically managed, deployed, updated, and evaluated for continuous evolution and adaptation.

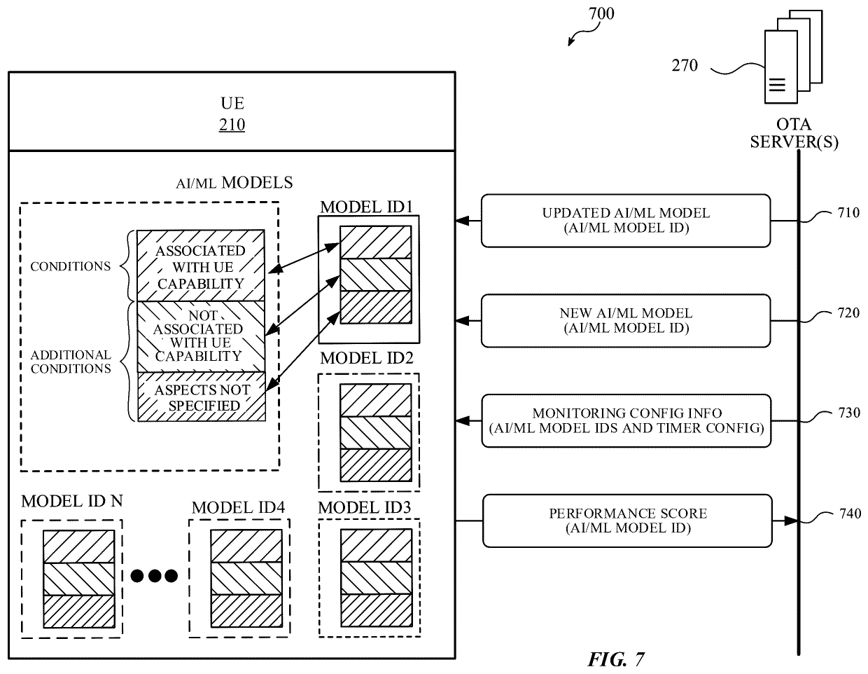

FIG. 7 is a diagram of an example of a process 700 of receiving, monitoring, and reporting performance results for AI/ML models according to one or more implementations described herein. As shown, process 700 can be implemented by UE 210 and OTA servers 270. In some implementations, some or all of process 700 can be performed by one or more other systems or devices, including one or more of the devices of FIG. 2. For example, process 700 can be implemented by UE 210 and another type of server or an entity of CN 230 or one or more application servers 240. Additionally, process 700 can include one or more fewer, additional, differently ordered and/or arranged operations than those shown in FIG. 7. In some implementations, some or all of the operations of process 700 can be performed independently, successively, simultaneously, etc., of one or more of the other operations of process 700. As such, the techniques described herein are not limited to a number, sequence, arrangement, timing, etc., of the operations or processes depicted in FIG. 7.

UE 210 can store one or more AI/ML models. Each AI/ML model can be associated with one or more attributes, such as a unique identifier (e.g., model ID1), conditions, and additional conditions. The AI/ML models of example 700 include model ID1, model ID2, model ID3, model ID4, . . . , and model IDN (where N is greater than or equal to 5). Each of the AI/ML models of example 600 can be associated with one or more conditions associated with UE capabilities and one or more additional conditions, including conditions not associated with UE capabilities and aspects that are not specified. Examples of these conditions and additional conditions are described above with reference to the preceding Figure.

Process 700 can include OTA servers 270 sending UE 210 an updated model associated with a model ID (e.g., Model ID1) (at 710). The model ID can be the same as the model ID of the prior version of the AI/ML model or a different model ID. When the model IDs are the same, OTA servers 270 can include an indication of a version of the updated AI/ML model. Process 700 can include OTA servers 270 sending UE 210 a new AI/ML model associated with a model ID (e.g., Model ID2) of the new AI/ML model. Process 700 can include OTA servers 270 sending UE 210 monitoring configuration information that includes model IDs and timer configurations (at 730). The model IDs, timer configurations, and monitoring configuration information can be configured to cause or enable UE 210 to monitor the performance of AI/ML models associated with the model IDs according to the timer configuration information.

UE 210 can monitor and evaluate the AI/ML models stored by UE 210 according to the monitoring configuration information. Doing so can result in performance scores representing an inference accuracy of the monitored AI/ML models. Process 700 can include UE 210 sending performance scores and corresponding model IDs to OTA servers 270 (at 740). Based on the performance scores, OTA servers 270 can determine whether to update, retrain, and/or create one or more AI/ML models, which OTA servers 270 can send to UE 210, thereby facilitating a continuous evolution and adaptation of AI/ML models used by UE 210.

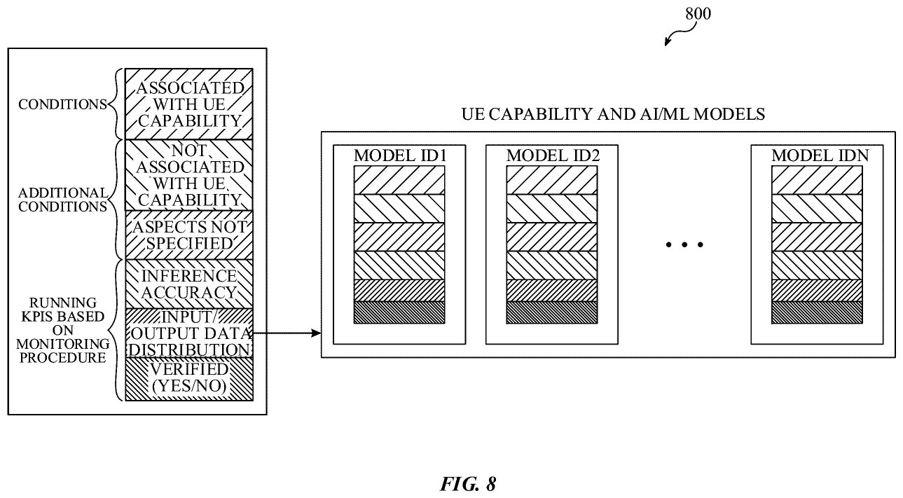

FIG. 8 is a diagram of example 800 of attributes associated with an AI/ML model according to one or more implementations described herein. UE 210 can store one or more AI/ML models (represented by model ID1, model ID2, . . . , and model IDN, where N is greater than or equal to 3)). Each AI/ML model can be associated with one or more additional attributes, such as conditions, and additional conditions. Examples of these conditions and additional conditions are described above with reference to the preceding Figures.

UE 210 can deploy, monitor, and evaluate the performance of AI/ML models to determine an inference accuracy of each AI/ML model. In doing so, UE 210 can also determine a data distribution for the input data used and/or a data distribution for the output data produced. UE 210 can also determine whether the AI/ML model is verified to operate under the conditions and/or additional conditions based the inference accuracy of the AI/ML model. UE 210 can update attributes associated with an AI/ML model to indicate an inference accuracy, input data distribution, output data distribution, and verification status of the AI/ML model. An inference accuracy, input data distribution, and output data distributing can be examples of KPIs as described herein. The verification status can indicate whether the AI/ML model is valid (e.g., whether the AI/ML model makes accurate predictions).

UE 210 can deploy, monitor, and evaluate the performance of active AI/ML models based on actual deployment conditions of UE 210. The actual deployment conditions can be indicated by OTA servers 270 and/or autonomously detected by UE based on UE side conditions. UE side conditions can include one or more conditions relating to a UE side of communications between UE 210 and base station 222.

UE 210 can also monitor and evaluate the performance of inactive AI/ML models when condition or additional condition attributes of an AI/ML model is consistent with the actual or current deployment conditions of UE 210. As such, performance of both active and inactive AI/ML models is determined according in accordance with specific or intended conditions (e.g., since the actual deployment conditions are consistent with the conditions and/or additional conditions attributes of the inactive AI/ML models).

In some implementations, UE 210 can also deploy, monitor, and evaluate the performance of inactive AI/ML models under active conditions even when the active conditions do not match the conditions and/or additional conditions attributes of the AI/ML models. For example, OTA servers 270 can identify AI/ML models that are at least partially suitable for monitoring and evaluation under current deployment conditions. Such AI/ML models can include those associated with additional conditions that partially satisfy the current conditions. OTA servers 270 can indicate the model IDs of these candidate AI/ML models, and UE 210 can monitor and evaluate the performance of the candidate models, update the performance score of the AI/ML models, and/or report the performance scores to OTA servers 270. In some implementations, UE 210 can autonomously identify candidate AI/ML models for performance monitoring, and evaluation, and reporting.

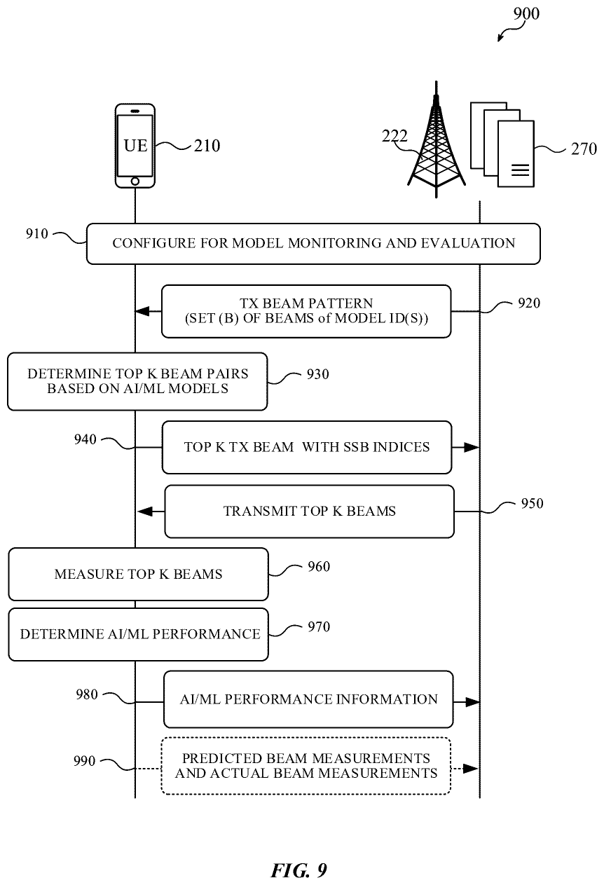

FIG. 9 is a diagram of example process 900 for dynamic model management and post-deployment verification for beam management and spatial predication according to one or more implementations described herein. Process 900 can be implemented by UE 210, base station 222, and OTA servers 270. In some implementations, some or all of process 900 can be performed by one or more other systems or devices, including one or more of the devices of FIG. 2. Additionally, process 900 can include one or more fewer, additional, differently ordered and/or arranged operations than those shown in FIG. 9. In some implementations, some or all of the operations of process 900 can be performed independently, successively, simultaneously, etc., of one or more of the other operations of process 900. As such, the techniques described herein are not limited to a number, sequence, arrangement, timing, etc., of the operations or processes depicted in FIG. 9.

As shown, UE 210 can receive configuration information from OTA servers 270 via base station 222 (at 910). The configuration information can indicate a set (B) of Tx beams to be transmitted by base station 222. The configuration information can also, or alternatively, indicate a model ID of one or more AI/ML models for evaluating the set (B) of Tx beams and corresponding Rx beams. The set (B) of Tx beams can include pilot beams, probing beams, or another type of beam from base station 222. UE 210 can receive the Tx beams and measure one or more characteristics of the Tx beams (at 920). UE 210 can also sweep, scan, and measure characteristics for a corresponding set of Rx beams from UE 210. The measurements can include an RSRP of the Tx beams and Rx beams.

UE 210 can select AI/ML models associated with model IDs sent by base station 222. The selected AI/ML models can include active and inactive AI/ML models. UE 210 can apply the measurements of the Tx beams and Rx beams as input data to the selected AI/ML models. Each AI/ML model can be a fully connected NN and can an output inference of a full RSRP map that predicts an RSRP value for each beam pair. A beam pair can include a Tx beam and a corresponding Rx beam. Each AI/ML model can predict a number (K) of top or best beam pairs. The number K can be any specified number (e.g., 2, 4, 6, 8, etc.) (at 930). The top K beam pairs can be beam pairs predicted to have the highest RSRP values. Each beam pair of the top K beam pairs can be represented as follows.
RSRPAI@UEtop-K

RSRP can be a predicted RSRP measurement or value; AI can be a model ID of an AI/ML model; UE can be an identifier of UE 210; and top-K can indicate that the RSRP measurement pertains to a top K beam pair and/or a rank within a top K beam pairs. UE 210 can identify a beam ID for each beam pair in each set of top K beam pairs predicted by the AI/ML models. UE 210 can communicate the beam IDs for each set of top K beam pairs to base station 222 (at 940). UE 210 can signal the top K beam pairs with SSB indices.

The SSB indices can enable UE 210 and base station 222 to synchronize time and frequency resources for transmission, reception, and measurement for the top K beam pairs. Base station 222 can transmit Tx beams for each of the top K beam pairs (at 950), and UE 210 can perform measurements for the top K Rx beams (960). The measurements can include an RSRP value for each beam pair. The RSRP value of each beam pair of the top K beam pairs can be represented as follows.

$$RSRPMeasUEtop - K$$

RSRP can be an actual or measured RSRP value; Meas can indicate that the RSRP value is an actual or measured RSRP; UE can be an identifier of UE 210; and top-K can indicate that the RSRP measurement pertains to a top K beam pair and or a rank within a top K beam pairs. UE 210 can determine a model performance score or validity metric for each AI/ML model based on the predicted RSRP value and the actual RSRP value of each of the top K beams of the corresponding AI/ML model (at 970). The function (ƒ) for determining a model performance score or validity metric can be represented as follows.

$$M = f ( R S R P M e a s U E t o p - K , RSRPAI @ UEtop - K )$$

M can be the model performance score, or validity metric of an AI/ML model associated with the model ID of AI. UE 210 can apply a filter to the performance scores or validity metrics to obtain a smoothing estimate of the inference accuracy of an AI/ML model. UE 210 can send base station 222 AI/ML performance information, such as performance scores, validity metrics, and or inference accuracy for each AI/ML model (at 980). Additionally, or alternatively, UE 210 can send base station 222 the predicated RSRP value and the measured RSRP value for each beam pair of the top K beams for each AI/ML model (at 990). In such scenarios, base station 222 can store the information and/or determine the performance scores, validity metrics, and or inference accuracy for each for each AI/ML model.

UE 210 can determine KPIs for deploying, monitoring, and evaluating AI/ML models. KPI-1 can include an inference accuracy, performance score, or a model monitoring score of an AI/ML model. KPI-1 can be determined based on an actual UE measurement (e.g., a measured RSRP) resulting from a non-AI/ML procedure and predicted measurement resulting from an AI/ML model configured to predict the output of the non-AI/ML procedure. KPI-1 can be determined based on the following expression.

$$M S = G ( f ( U {E}_{m e a s u r e} , U {E}_{AI / ML} ) )$$

MS can be a model monitoring score; UE_{AI/ML} a predicted beam measurement (e.g., an RSRP value predicted by an AI/ML model); UEₘₑₐₛᵤᵣₑ can be an actual beam measurement (e.g., an RSRP value actually measured by UE 210); and G can be a smoothing function configured to filter individual monitoring measurements (e.g., infinite impulse response (IIR) filtering).

KPI-2 can include a distribution of data representing output inferences generated by an AI/ML model relative to normal or acceptable distributions of output data from AI/ML models. The output of an AI/ML model can be monitored to detect anomalous behavior (e.g., outlier detection) based on previously computed samples (e.g., IIR filtering and classification functions from an algorithm to detect drift or change in output and behavior). For example, KPI-2 can help determine when predicted RSRPs associated with one or more one or more beam IDs suddenly change (e.g., a change beyond a change threshold). When a distribution of output data from an AI/ML model experiences an abrupt or anomalous change, UE 210 can determine that the AI/ML model has drifted and is no longer verified or valid and an inference accuracy need not be determined.

KPI-3 can include conditions for deploying an AI/ML model and/or a distribution of input data for the AI/ML model. UE 210 can determine KPI-3 based on determining whether a distribution of input data is has suddenly changed, is an outlier, or is otherwise anomalous or atypical, relative to normal or acceptable distributions of input data for the AI/ML model. For example, when one or more beams of a beam set (B) are blocked, UE 210 can determine that the currently monitored AI/ML model is not valid or does not justify monitoring. UE 210 can communicate this to base station 222 such that the AI/ML model is switched for a more suitable AI/ML model. Examples of KPI-3 conditions can include an SNR, doppler measurement, delay spread, etc. (that are not part of additional conditions of the deployed AI/ML model). In short, KPI-3 can be used to predicate whether or not an AI/ML model will perform well given a set of conditions or input data.

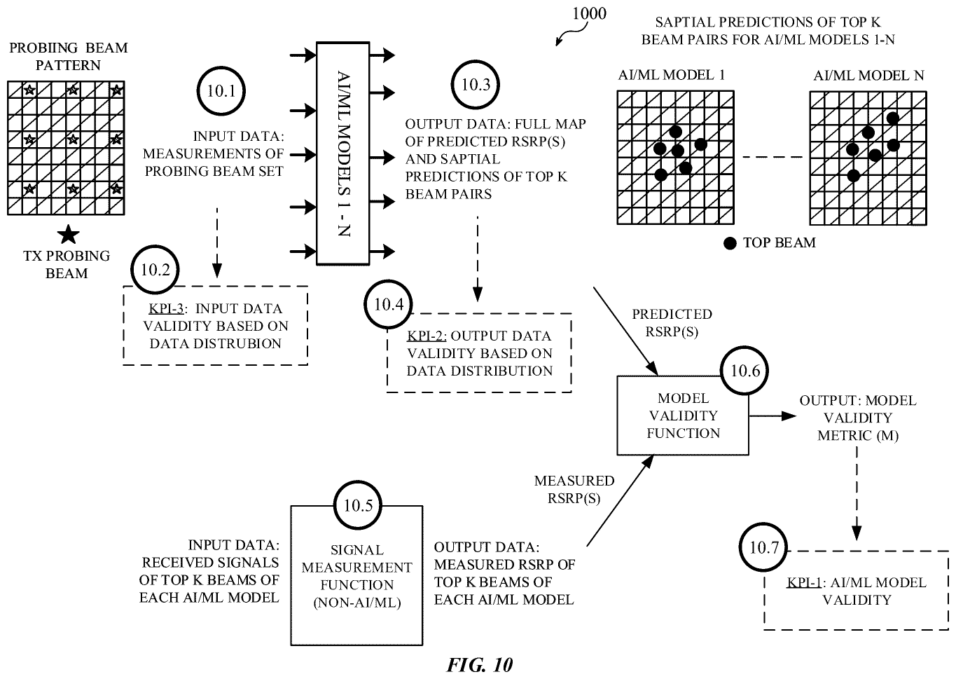

FIG. 10 is a diagram of an example 1000 of KPIs for dynamic model management and post-deployment verification for beam management and spatial predication according to one or more implementations described herein. Example 1000 can be implemented by UE 210 and base station 222. For example, base station 222 can transmit probing beams to UE 210 according to a Tx probing beam pattern. The probing beams can be a set of probing beams (B) corresponding to a Tx probing codebook or set of beams. The probing beams can be transmitted according to a beam pattern and schedule such that UE 210 can detect and measure the probing beams as well as sweep or scan for corresponding Rx beams of UE 210 as well.

In some implementations, the set of probing beams or beam pattern can be specific, or configured for, AI/ML models deployed by UE 210. For example, base station 222 can select or determine the set of probing beams or the beam pattern based on AI/ML models deployed by UE 210. In some implementations, the AI/ML models deployed by UE 210 can be specific to, or configured for, the set of probing beams or beam pattern. For example, UE 210 can select the AI/ML models based on the probing beams or beam pattern transmitted by base station 222. UE 210 can deploy any number of AI/ML models. For instance, example 1000 can include AI/ML model 1, AI/ML model 2, . . . , and AI/ML model N (where N is greater than or equal to 3). The AI/ML models can be active, inactive, or a combination of active AI/ML model and inactive AI/ML models. UE 210 can generate input data for AI/ML models based on Tx/Rx beam pairs and the measurement results (at 10.1).

Prior to applying the input data to the AI/ML models, UE 210 can analyze and evaluate the input data to determine a KPI-3 for the input data (at 10.2). KPI-3 can include an indication of whether the input data is valid or invalid for the AI/ML models. UE 210 can determine KPI-3 based on operating conditions relative to measuring the set of probing beams (e.g., an SNR, doppler measurement, delay spread, etc.). UE 210 can also, or alternatively, determine KPI-3 by determining whether the input data is consistent with normal, typical, or otherwise acceptable input data. UE 210 can analyze and evaluate the input data differently for different AI/ML models, such that UE 210 produces a KPI-3 for each AI/ML model.

In some implementations, UE 210 can generate a data distribution representing the input data and compare the data distribution to a data distribution model developed using many sets of normal or otherwise acceptable input data for the AI/ML models. When UE 210 determines that the input data comprises an outlier, anomaly, or otherwise unacceptable set of input data, UE 210 can determine the input data to be invalid. In such a scenario, UE 210 can refrain from applying the input data to the AI/ML models and determining whether the AI/ML models are valid or invalid. When UE 210 determines that the input data is normal or otherwise acceptable (e.g., for lacking outliers, anomalies, etc.), UE 210 can apply the input data to the AI/ML models.

The AI/ML models can produce output data (e.g., an output inference) that includes full map of predicted RSRPs based on the input data (e.g., based on the measurements of Tx/Rx beam pairs resulting from the set of probing beams) (at 10.3). The AI/ML models can evaluate the full map of predicted RSRPs to determine a top number (K) of beam pairs. The top K beam pairs can consist of beam pairs predicted to have the highest RSRP. UE 210 can generate a full map of predicted RSRPs for each AI/ML model, as well as corresponding set of a top K beam pairs.

UE 210 can determine a KPI-2 for each of the AI/ML models (at 10.4). KPI-2 can include an indication of whether the output data is valid. Whether the output data is valid can depend on whether the output data can be relied upon to accurately determine whether a corresponding AI/ML model is valid (KPI-1). The manner in which the output data is analyzed and evaluated can be different for each of the AI/ML models, and different AI/ML models can have different KPI-2 values.

KPI-2 can refer to a distribution of an output data (e.g., predicted RSRPs) of an AI/ML model. UE 210 can determine whether the distribution of an inference output is consistent with distributions of normal or accurate inference outputs relating to RSRP and beam pairs. UE 210 can determine a KPI-2 for a particular AI/ML model using one or more tools, such as support vector machine (SVM) or one-class SVM. UE 210 can determine whether the data distribution of output data includes any anomalies or another types of distributions that are indicative of the AI/ML model not operating properly or having drifted away acceptable operational parameters.

A SVM is a ML algorithm used for the classification and outlier detection of data points within a feature space. SVM algorithms can find an optimal hyperplane in an N-dimensional space that can separate data points in different classes in a feature space. The hyperplane of a 2-dimensional space can be a line separating two classes or categories of vectors or data points. An optimal hyperplane in a 2-dimensional space is a line that maximizes a distance between the closest data points (or vectors) of different classes in the feature space.

A one-class SVM can use a kernel function to map input data to a higher-dimensional space where the data points are more separable. The one-class SVM can include a common kernel, such as a linear kernel, polynomial kernel 1, radial bases function (RBF) kernel, or a sigmoid kernel. The training process for building the distribution model can involve fitting the one-class SVM model to the normal data points. An SVM algorithm can find an optimal hyperplane in an N-dimensional space that can separate data points in different classes in a feature space. The hyperplane of a 2-dimensional space can be a line separating two classes or categories of vectors or data points. An optimal hyperplane in a 2-dimensional space is a line that maximizes a distance between the closest data points (or vectors) of different classes in the feature space.

UE 210 can generate a data distribution representing output data generated by an AI/ML model. The data distribution can include a 2-dimensional representing (e.g., latent space (C) of the output data of an AI/ML model. A latent space (C) can include an abstract, multi-dimensional space containing feature values that encodes a meaningful internal representation of external information. The latent space can include quantitative spatial representation or model of input values. UE 210 can create a latent space with a distribution of output data (e.g., predicted RSRP values). UE 210 can apply the data distribution to a data distribution model generated by the one-class SVM and determine whether the output data of the AI/ML model is valid or invalid based on the output data relative to a hyperplane determined by the SVM.

When KPI-2 indicates that the AI/ML model is not valid, UE 210 can refrain from determining an inference accuracy of the AI/ML model. When KPI-2 indicates that the AI/ML model is valid, UE 210 can send base station 222 an indication of the top K beam pairs predicted by the AI/ML model. Base station 222 can transmit signals to UE 210 using the top K beams. UE 210 can use a signal measurement function to measure characteristics of the top K beams and determine an actual RSRP for each beam of the top K beams (at 10.5).

UE 210 can apply the predicted RSRPs and the measured RSRPs of one or more of the top K beams to a model validity function (ƒ) to produce a model validity metric (M) for the one or more of the top K beams (at 10.6). Model validity can refer to an indication or determination that an AI/ML model produces output inferences with a threshold degree of inference accuracy under conditions and/or when receiving input data consistent with how the AI/ML model was designed and trained to function.

Additionally, UE 210 can apply a smoothing function to the validity metrics (M) generated by the validity function (ƒ) to determine a KPI-1 for the AI/ML model (at 10.7). The KPI-1 can indicate whether the AI/ML model is valid or invalid. In some implementations, an AI/ML model is valid when a KPI-1 for the AI/ML model is above a validity threshold, within a range of acceptable validity metrics, or within a range of acceptability. While not shown, UE 210 can update a local dataset or record of attributes associated with the AI/ML model with the KPI-1 or a corresponding validity status. Additionally, or alternatively, UE 210 can communicate the KPI-1 or validity status of the AI/ML model to baes station 222 or OTA server 270.

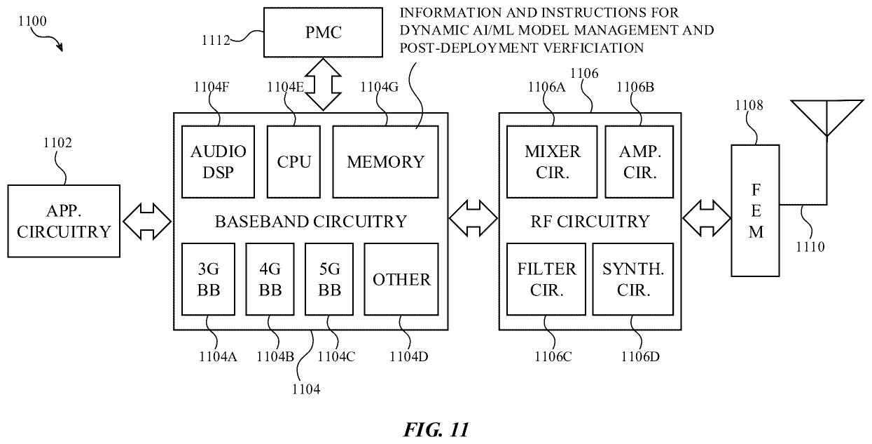

FIG. 11 is a diagram of an example of components of a device according to one or more implementations described herein. In some implementations, the device 1100 can include application circuitry 1102, baseband circuitry 1104, RF circuitry 1106, front-end module (FEM) circuitry 1108, one or more antennas 1110, and power management circuitry (PMC) 1112 coupled together at least as shown. The components of the illustrated device 1100 can be included in a UE or a RAN node. In some implementations, the device 1100 can include fewer elements (e.g., a RAN node may not utilize application circuitry 1102, and instead include a processor/controller to process IP data received from a CN or an Evolved Packet Core (EPC)). In some implementations, the device 1100 can include additional elements such as, for example, memory/storage, display, camera, sensor (including one or more temperature sensors, such as a single temperature sensor, a plurality of temperature sensors at different locations in device 1100, etc.), or input/output (I/O) interface. In other implementations, the components described below can be included in more than one device (e.g., said circuitries can be separately included in more than one device for Cloud-RAN (C-RAN) implementations).

The application circuitry 1102 can include one or more application processors. For example, the application circuitry 1102 can include circuitry such as, but not limited to, one or more single-core or multi-core processors. The processor(s) can include any combination of general-purpose processors and dedicated processors (e.g., graphics processors, application processors, etc.). The processors can be coupled with or can include memory/storage and can be configured to execute instructions stored in the memory/storage to enable various applications or operating systems to run on the device 1100. In some implementations, processors of application circuitry 1102 can process IP data packets received from an EPC.

The baseband circuitry 1104 can include circuitry such as, but not limited to, one or more single-core or multi-core processors. The baseband circuitry 1104 can include one or more baseband processors or control logic to process baseband signals received from a receive signal path of the RF circuitry 1106 and to generate baseband signals for a transmit signal path of the RF circuitry 1106. Baseband circuitry 1104 can interface with the application circuitry 1102 for generation and processing of the baseband signals and for controlling operations of the RF circuitry 1106. For example, in some implementations, the baseband circuitry 1104 can include a 3G baseband processor 1104A, a 4G baseband processor 1104B, a 5G baseband processor 1104C, or other baseband processor(s) 1104D for other existing generations, generations in development or to be developed in the future (e.g., 5G, 6G, etc.). The baseband circuitry 1104 (e.g., one or more of baseband processors 1104A, 1104B, 1104C, and 1104D) can handle various radio control functions that enable communication with one or more radio networks via the RF circuitry 1106. In other implementations, some or all of the functionality of baseband processors 1104A, 1104B, 1104C, 1104D can be included in modules stored in the memory 1104G and executed via a Central Processing Unit (CPU) 1104E. The radio control functions can include, but are not limited to, signal modulation/demodulation, encoding/decoding, radio frequency shifting, etc. In some implementations, modulation/demodulation circuitry of the baseband circuitry 1104 can include Fast-Fourier Transform (FFT), precoding, or constellation mapping/de-mapping functionality. In some implementations, encoding/decoding circuitry of the baseband circuitry 1104 can include convolution, tail-biting convolution, turbo, Viterbi, or Low-Density Parity Check (LDPC) encoder/decoder functionality. Implementations of modulation/demodulation and encoder/decoder functionality are not limited to these examples and can include other suitable functionality in other implementations.

In some implementations, memory 1104G can receive and/or store information and instructions for dynamic model management and post-deployment verification for beam management spatial prediction. For example, UE 210 can receive multiple AI/ML models from OTA server 270. UE 210 can deploy, monitor, and evaluate active and inactive AI/ML models according to one or more KPIs, such as input data and conditions associated with the AI/ML model, a distribution of output data produced by the AI/ML model, and an inference accuracy of the AI/ML model. UE 210 can determine that an AI/ML model is verified when KPIs are satisfied. These and many other features and examples are described herein.

In some implementations, the baseband circuitry 1104 can include one or more audio digital signal processor(s) (DSP) 1104F. The audio DSPs 1104F can include elements for compression/decompression and echo cancellation and can include other suitable processing elements in other implementations. Components of the baseband circuitry can be suitably combined in a single chip, a single chipset, or disposed on a same circuit board in some implementations. In some implementations, some or all of the constituent components of the baseband circuitry 1104 and the application circuitry 1102 can be implemented together such as, for example, on a system on a chip (SOC).

In some implementations, the baseband circuitry 1104 can provide for communication compatible with one or more radio technologies. For example, in some implementations, the baseband circuitry 1104 can support communication with a NG-RAN, an evolved universal terrestrial radio access network (EUTRAN) or other wireless metropolitan area networks (WMAN), a wireless local area network (WLAN), a wireless personal area network (WPAN), etc. Implementations in which the baseband circuitry 1104 is configured to support radio communications of more than one wireless protocol can be referred to as multi-mode baseband circuitry.

RF circuitry 1106 can enable communication with wireless networks using modulated electromagnetic radiation through a non-solid medium. In various implementations, the RF circuitry 1106 can include switches, filters, amplifiers, etc. to facilitate the communication with the wireless network. RF circuitry 1106 can include a receive signal path which can include circuitry to down-convert RF signals received from the FEM circuitry 1108 and provide baseband signals to the baseband circuitry 1104. RF circuitry 1106 can also include a transmit signal path which can include circuitry to up-convert baseband signals provided by the baseband circuitry 1104 and provide RF output signals to the FEM circuitry 1108 for transmission.

In some implementations, the receive signal path of the RF circuitry 1106 can include mixer circuitry 1106A, amplifier circuitry 1106B and filter circuitry 1106C. In some implementations, the transmit signal path of the RF circuitry 1106 can include filter circuitry 1106C and mixer circuitry 1106A. RF circuitry 1106 can also include synthesizer circuitry 1106D for synthesizing a frequency for use by the mixer circuitry 1106A of the receive signal path and the transmit signal path. In some implementations, the mixer circuitry 1106A of the receive signal path can be configured to down-convert RF signals received from the FEM circuitry 1108 based on the synthesized frequency provided by synthesizer circuitry 1106D. The amplifier circuitry 1106B can be configured to amplify the down-converted signals and the filter circuitry 1106C can be a low-pass filter (LPF) or band-pass filter (BPF) configured to remove unwanted signals from the down-converted signals to generate output baseband signals. Output baseband signals can be provided to the baseband circuitry 9404 for further processing. In some implementations, the output baseband signals can be zero-frequency baseband signals, although this is not a requirement. In some implementations, mixer circuitry 1106A of the receive signal path can comprise passive mixers, although the scope of the implementations is not limited in this respect.

In some implementations, the mixer circuitry 1106A of the transmit signal path can be configured to up-convert input baseband signals based on the synthesized frequency provided by the synthesizer circuitry 1106D to generate RF output signals for the FEM circuitry 1108. The baseband signals can be provided by the baseband circuitry 1104 and can be filtered by filter circuitry 1106C. In some implementations, the mixer circuitry 06A of the receive signal path and the mixer circuitry 1906A of the transmit signal path can include two or more mixers and can be arranged for quadrature down conversion and up conversion, respectively. In some implementations, the mixer circuitry 1106A of the receive signal path and the mixer circuitry 1106A of the transmit signal path can include two or more mixers and can be arranged for image rejection (e.g., Hartley image rejection). In some implementations, the mixer circuitry 06A of the receive signal path and the mixer circuitry 906A can be arranged for direct down conversion and direct up conversion, respectively. In some implementations, the mixer circuitry 11069 of the receive signal path and the mixer circuitry 1106A of the transmit signal path can be configured for super-heterodyne operation.

In some implementations, the output baseband signals, and the input baseband signals can be analog baseband signals, although the scope of the implementations is not limited in this respect. In some alternate implementations, the output baseband signals, and the input baseband signals can be digital baseband signals. In these alternate implementations, the RF circuitry 1106 can include analog-to-digital converter (ADC) and digital-to-analog converter (DAC) circuitry and the baseband circuitry 1104 can include a digital baseband interface to communicate with the RF circuitry 1106.

In some dual-mode implementations, a separate radio IC circuitry can be provided for processing signals for each spectrum, although the scope of the implementations is not limited in this respect. In some implementations, the synthesizer circuitry 1106D can be a fractional-N synthesizer or a fractional N/N+1 synthesizer, although the scope of the implementations is not limited in this respect as other types of frequency synthesizers can be suitable. For example, synthesizer circuitry 1106D can be a delta-sigma synthesizer, a frequency multiplier, or a synthesizer comprising a phase-locked loop with a frequency divider.

The synthesizer circuitry 1106D can be configured to synthesize an output frequency for use by the mixer circuitry 1106A of the RF circuitry 1106 based on a frequency input and a divider control input. In some implementations, the synthesizer circuitry 1106D can be a fractional N/N+1 synthesizer.

In some implementations, frequency input can be provided by a voltage-controlled oscillator (VCO), although that is not a requirement. Divider control input can be provided by either the baseband circuitry 1104 or the applications circuitry 1102 depending on the desired output frequency. In some implementations, a divider control input (e.g., N) can be determined from a look-up table based on a channel indicated by the applications circuitry 1102.

Synthesizer circuitry 1106D of the RF circuitry 1106 can include a divider, a delay-locked loop (DLL), a multiplexer and a phase accumulator. In some implementations, the divider can be a dual modulus divider (DMD), and the phase accumulator can be a digital phase accumulator (DPA). In some implementations, the DMD can be configured to divide the input signal by either N or N+1 (e.g., based on a carry out) to provide a fractional division ratio. In some example implementations, the DLL can include a set of cascaded, tunable, delay elements, a phase detector, a charge pump and a D-type flip-flop. In these implementations, the delay elements can be configured to break a VCO period up into Nd equal packets of phase, where Nd is the number of delay elements in the delay line. In this way, the DLL provides negative feedback to help ensure that the total delay through the delay line is one VCO cycle.

In some implementations, synthesizer circuitry 1106D can be configured to generate a carrier frequency as the output frequency, while in other implementations, the output frequency can be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some implementations, the output frequency can be a LO frequency (fLO). In some implementations, the RF circuitry 1106 can include an IQ/polar converter.

FEM circuitry 1108 can include a receive signal path which can include circuitry configured to operate on RF signals received from one or more antennas 1110, amplify the received signals and provide the amplified versions of the received signals to the RF circuitry 1106 for further processing. FEM circuitry 1108 can also include a transmit signal path which can include circuitry configured to amplify signals for transmission provided by the RF circuitry 1106 for transmission by one or more of the one or more antennas 1110. In various implementations, the amplification through the transmit or receive signal paths can be done solely in the RF circuitry 1106, solely in the FEM circuitry 1108, or in both the RF circuitry 1106 and the FEM circuitry 1108.

In some implementations, the FEM circuitry 1108 can include a TX/RX switch to switch between transmit mode and receive mode operation. The FEM circuitry can include a receive signal path and a transmit signal path. The receive signal path of the FEM circuitry can include an LNA to amplify received RF signals and provide the amplified received RF signals as an output (e.g., to the RF circuitry 1106). The transmit signal path of the FEM circuitry 1108 can include a power amplifier (PA) to amplify input RF signals (e.g., provided by RF circuitry 1106), and one or more filters to generate RF signals for subsequent transmission (e.g., by one or more of the one or more antennas 1110).

In some implementations, the PMC 1112 can manage power provided to the baseband circuitry 1104. In particular, the PMC 1112 can control power-source selection, voltage scaling, battery charging, or DC-to-DC conversion. The PMC 1112 can often be included when the device 1100 is capable of being powered by a battery, for example, when the device is included in a UE. The PMC 1112 can increase the power conversion efficiency while providing desirable implementation size and heat dissipation characteristics.

While FIG. 11 shows the PMC 1112 coupled only with the baseband circuitry 1104. However, in other implementations, the PMC 1112 can be additionally or alternatively coupled with, and perform similar power management operations for, other components such as, but not limited to, application circuitry 1102, RF circuitry 1106, or FEM circuitry 1108.

In some implementations, the PMC 1112 can control, or otherwise be part of, various power saving mechanisms of the device 1100. For example, if the device 1100 is in an RRC_Connected state, where it is still connected to the RAN node as it expects to receive traffic shortly, then it can enter a state known as Discontinuous Reception Mode (DRX) after a period of inactivity. During this state, the device 1100 can power down for brief intervals of time and thus save power.

If there is no data traffic activity for an extended period of time, then the device 1100 can transition off to an RRC_Idle state, where it disconnects from the network and does not perform operations such as channel quality feedback, handover, etc. The device 1100 goes into a very low power state and it performs paging where again it periodically wakes up to listen to the network and then powers down again. The device 1100 may not receive data in this state; in order to receive data, it can transition back to RRC_Connected state.

An additional power saving mode can allow a device to be unavailable to the network for periods longer than a paging interval (ranging from seconds to a few hours). During this time, the device is unreachable to the network and can power down completely. Any data sent during this time incurs a large delay and it is assumed the delay is acceptable.

Processors of the application circuitry 1102 and processors of the baseband circuitry 1104 can be used to execute elements of one or more instances of a protocol stack. For example, processors of the baseband circuitry 1104, alone or in combination, can be used execute Layer 3, Layer 2, or Layer 1 functionality, while processors of the baseband circuitry 1104 can utilize data (e.g., packet data) received from these layers and further execute Layer 4 functionality (e.g., transmission communication protocol (TCP) and user datagram protocol (UDP) layers). As referred to herein, Layer 3 can comprise a RRC layer, described in further detail below. As referred to herein, Layer 2 can comprise a medium access control (MAC) layer, a radio link control (RLC) layer, and a packet data convergence protocol (PDCP) layer, described in further detail below. As referred to herein, Layer 1 can comprise a physical (PHY) layer of a UE/RAN node, described in further detail below.

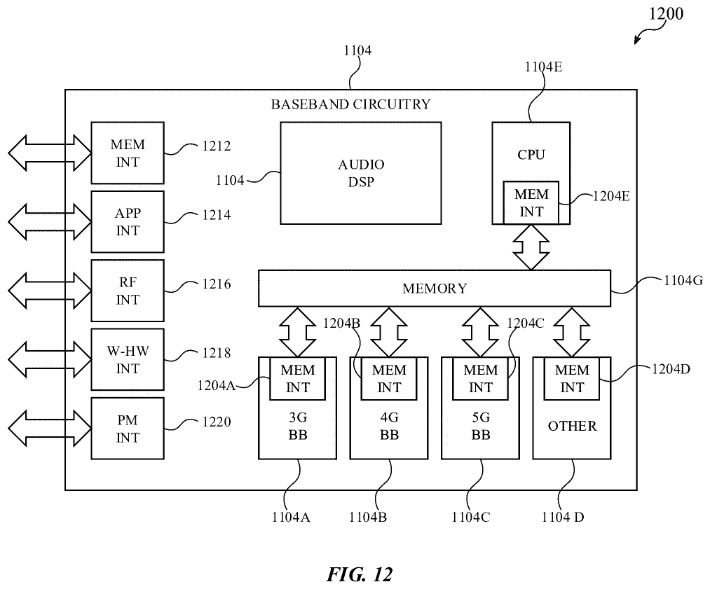

FIG. 12 is a diagram of example interfaces 1200 of baseband circuitry according to one or more implementations described herein. As discussed above, the baseband circuitry 1104 of FIG. 11 can comprise processors 1104A, 1104B, 1104C, 1104D, and 1104E and a memory 1104G utilized by said processors. Each of the processors 1104A, 1104B, 1104C, 1104D, and 1104E can include a memory interface, 1204A, 1204B, 1204C, 1204D, and 1204E, respectively, to send/receive data to/from the memory 1104G.

In some implementations, memory 1104G can receive, store, and/or provide information and instructions for dynamic model management and post-deployment verification for beam management spatial prediction. For example, UE 210 can receive multiple AI/ML models from OTA server 270. UE 210 can deploy, monitor, and evaluate active and inactive AI/ML models according to one or more KPIs, such as input data and conditions associated with the AI/ML model, a distribution of output data produced by the AI/ML model, and an inference accuracy of the AI/ML model. UE 210 can determine that an AI/ML model is verified when KPIs are satisfied. These and many other features and examples are described herein.

The baseband circuitry 1104 can further include one or more interfaces to communicatively couple to other circuitries/devices, such as a memory interface 1212 (e.g., an interface to send/receive data to/from memory external to the baseband circuitry 1104), an application circuitry interface 1114 (e.g., an interface to send/receive data to/from the application circuitry 1102 of FIG. 11), an RF circuitry interface 1116 (e.g., an interface to send/receive data to/from RF circuitry 1106 of FIG. 11), a wireless hardware connectivity interface 1218 (e.g., an interface to send/receive data to/from Near Field Communication (NFC) components, Bluetooth® components (e.g., Bluetooth® Low Energy), Wi-Fi® components, and other communication components), and a power management interface 1220 (e.g., an interface to send/receive power or control signals to/from the PMC 1112).

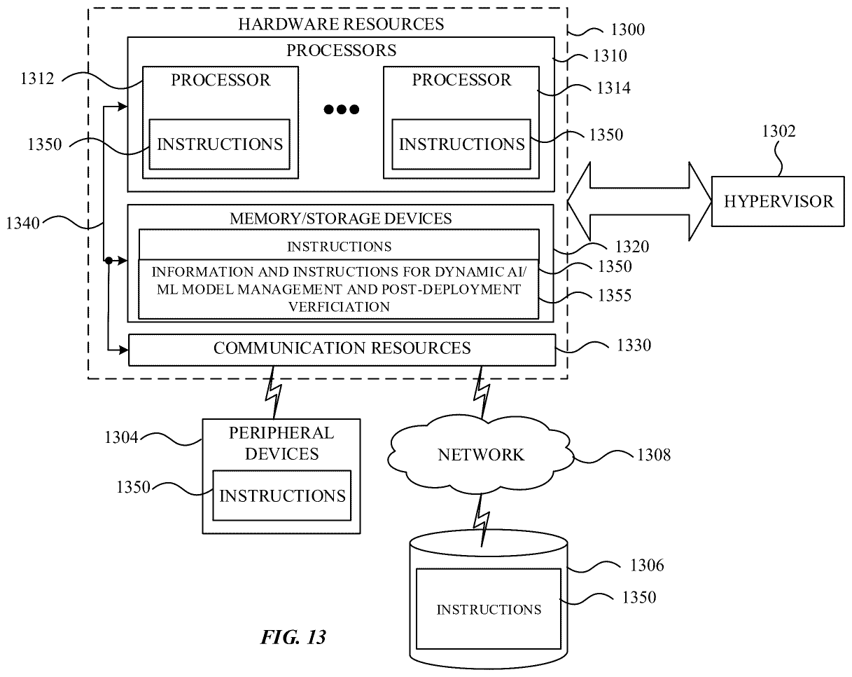

FIG. 13 is a block diagram illustrating components, according to some example implementations, able to read instructions from a machine-readable or computer-readable medium (e.g., a non-transitory machine-readable storage medium) and perform any one or more of the methodologies discussed herein. Specifically, FIG. 13 shows a diagrammatic representation of hardware resources 1300 including one or more processors (or processor cores) 1310, one or more memory/storage devices 1310, and one or more communication resources 1330, each of which can be communicatively coupled via a bus 1340. For implementations where node virtualization (e.g., NFV) is utilized, a hypervisor can be executed to provide an execution environment for one or more network slices/sub-slices to utilize the hardware resources 1300. The hardware resources 1300 can interact with the hypervisor 1302. For example, the hypervisor 1302 can schedule or otherwise manage the hardware resource 1300.

The processors 1310 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) can include, for example, a processor 1312 and a processor 1314.

The memory/storage devices 1310 can include main memory, disk storage, or any suitable combination thereof. The memory/storage devices 1310 can include, but are not limited to any type of volatile or non-volatile memory such as dynamic random-access memory (DRAM), static random-access memory (SRAM), erasable programmable read-only memory (EPROM), electrically erasable programmable read-only memory (EEPROM), Flash memory, solid-state storage, etc.

In some implementations, memory/storage devices 1310 receive and/or store information and instructions 1355 for dynamic model management and post-deployment verification for beam management spatial prediction. For example, UE 210 can receive multiple AI/ML models from OTA server 270. UE 210 can deploy, monitor, and evaluate active and inactive AI/ML models according to one or more KPIs, such as input data and conditions associated with the AI/ML model, a distribution of output data produced by the AI/ML model, and an inference accuracy of the AI/ML model. UE 210 can determine that an AI/ML model is verified when KPIs are satisfied. These and many other features and examples are described herein.

The communication resources 1330 can include interconnection or network interface components or other suitable devices to communicate with one or more peripheral devices 1304 or one or more databases 1306 via a network 1308. For example, the communication resources 1330 can include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 1350 can comprise software, a program, an application, an applet, an app, or other executable code for causing at least any of the processors 1310 to perform any one or more of the methodologies discussed herein. The instructions 1350 can reside, completely or partially, within at least one of the processors 1310 (e.g., within the processor's cache memory), the memory/storage devices 1310, or any suitable combination thereof. Furthermore, any portion of the instructions 1350 can be transferred to the hardware resources 1300 from any combination of the peripheral devices 1304 or the databases 1306. Accordingly, the memory of processors 1310, the memory/storage devices 1310, the peripheral devices 1304, and the databases 1306 are examples of computer-readable and machine-readable media.

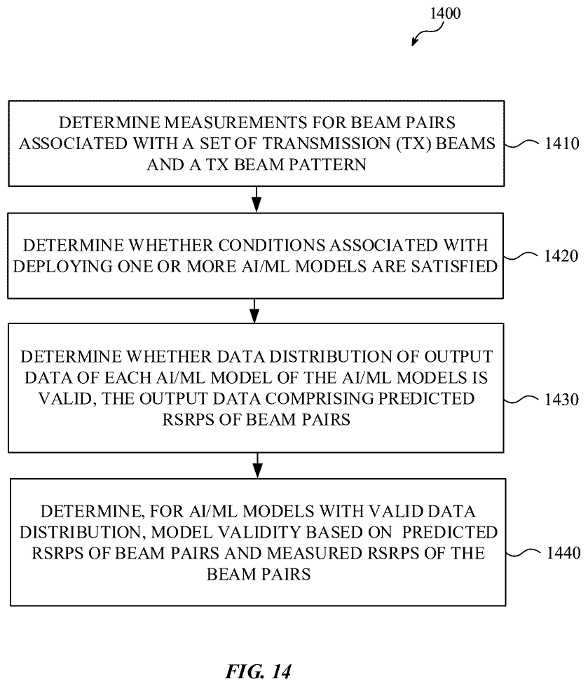

FIG. 14 is a diagram of an example process 1400 for dynamic model management and post-deployment verification for beam management spatial prediction according to one or more implementations described herein. Process 1400 can be implemented by UE 210 or baseband circuitry 1100. In some implementations, some or all of process 1400 can be performed by one or more other systems or devices, including one or more of the devices of FIG. 2. Additionally, process 1400 can include one or more fewer, additional, differently ordered and/or arranged operations than those shown in FIG. 14. In some implementations, some or all of the operations of process 1400 can be performed independently, successively, simultaneously, etc., of one or more of the other operations of process 1400. As such, the techniques described herein are not limited to a number, sequence, arrangement, timing, etc., of the operations or processes depicted in FIG. 14.

Process 1400 can include determining measurements for beam pairs associated with a set of Tx beams and a Tx beam pattern (block 1410). Process 1400 can include determining whether conditions associated with deploying one or more AI/ML models are satisfied (block 1410). Process 1400 can include determining whether a data distribution of output data of each AI/ML model of the one or more AI/ML models is valid, the output data comprising predicted RSRPs of beam pairs (block 1410). Process 1400 can include determining, for the one or more AI/ML models with a valid data distribution, a model validity based on the predicted RSRPs and measured RSRPs of the same beam pairs. (block 1410). These and many other features and examples are described herein.

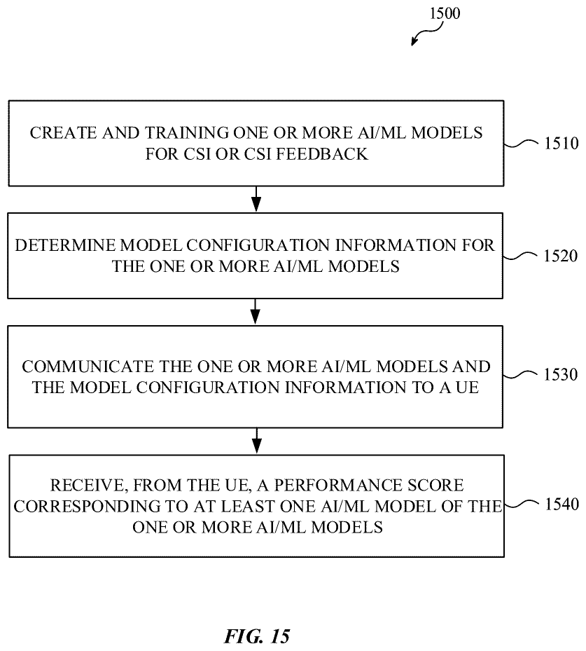

FIG. 15 is a diagram of an example process 1500 dynamic model management and post-deployment verification for CSI according to one or more implementations described herein. Process 1400 can be implemented by UE 210 or baseband circuitry 1200. In some implementations, some or all of process 1500 can be performed by one or more other systems or devices, including one or more of the devices of FIG. 2. Additionally, process 1500 can include one or more fewer, additional, differently ordered and/or arranged operations than those shown in FIG. 15. In some implementations, some or all of the operations of process 1500 can be performed independently, successively, simultaneously, etc., of one or more of the other operations of process 1500. As such, the techniques described herein are not limited to a number, sequence, arrangement, timing, etc., of the operations or processes depicted in FIG. 15.

Process 1500 can include creating and training one or more AI/ML models for CSI or CSI feedback (block 1510). Process 1500 can include determining model configuration information for the one or more AI/ML models (block 1520). Process 1500 can include communicating the one or more AI/ML models and the model configuration information to a UE (block 1530). Process 1500 can include receiving, from the UE, a performance score corresponding to at least one AI/ML model of the one or more AI/ML models (block 1540). These and many other features and examples are described herein

Examples herein can include subject matter such as a method, means for performing acts or blocks of the method, at least one machine-readable medium including executable instructions that, when performed by a machine (e.g., a processor (e.g., processor, etc.) with memory, an application-specific integrated circuit (ASIC), a field programmable gate array (FPGA), or the like) cause the machine to perform acts of the method or of an apparatus or system for concurrent communication using multiple communication technologies according to implementations and examples described.

In example 1, which can also include one or more of the examples described herein, a device can comprise: a memory; and one or more processors configured to, when executing instructions stored in the memory, cause the device to: determine measurements for beam pairs associated with a set of transmission (Tx) beams and a Tx beam pattern; determine whether conditions associated with deploying one or more artificial intelligence (AI)/machine learning (ML) models are satisfied; determine whether a data distribution of output data of each AI/ML model of the one or more AI/ML models is valid, the output data comprising predicted reference signal received powers (RSRPs) of a plurality of beam pairs; determine, for the one or more AI/ML models with the valid data distribution, a model validity based on the predicted RSRPs of the plurality of beam pairs and measured RSRPs of the plurality of beam pairs.

In example 2, which can also include one or more of the examples described herein, the one or more processors are configured to cause the device to: select at least one beam pair based on a predicted RSRP of a valid AI/ML model; and communicate with the base station using the at least one beam pair.

In example 3, which can also include one or more of the examples described herein, the device comprises a user equipment (UE) or the device comprises baseband circuitry.

In example 4, which can also include one or more of the examples described herein, the one or more AI/ML models is configured to generate the output data based on the beam pairs associated with a set of transmission beams and the Tx beam pattern.

In example 5, which can also include one or more of the examples described herein, the output data comprises a full RSRP map for all beam pairs.

In example 6, which can also include one or more of the examples described herein, the output data comprises a top number of beam pairs with the highest RSRP values.

In example 7, which can also include one or more of the examples described herein, the plurality of beam pairs comprises the top number of beam pairs.

In example 8, which can also include one or more of the examples described herein, the model validity is based on a degree of accuracy of the predicted RSRPs of the plurality of beam pairs relative to the measured RSRPs of the plurality of beam pairs.

In example 9, which can also include one or more of the examples described herein, the one or more processors are configured to cause the device to: determine model validity metrics for the plurality of beam pairs based on the RSRPs and the measured RSRPs of the plurality of beam pairs; and the model validity is further based on a smoothing function applied to the model validity metrics.

In example 10, which can also include one or more of the examples described herein, the measurements for the beam pairs are determined based on a combination of Tx beams and corresponding receiving (Rx) beams of a beam sweep.

In example 11, which can also include one or more of the examples described herein, the one or more processors are configured to cause the device to: determine a top number of beam pairs based on the predicted RSRPs; and communicate an indication of the top number of beam pairs to a base station; and determine the measured RSRPs based on a transmission of the top number of beam pairs.

In example 12, which can also include one or more of the examples described herein, the one or more processors are configured to cause the device to: determine performance score for each AI/ML model of the one or more AI/ML models based on the predicted RSRPs of the plurality of beam pairs and measured RSRPs of the plurality of beam pairs.

In example 13, which can also include one or more of the examples described herein, the one or more processors are configured to cause the device to: update a locally stored record of each AI/ML model of the one or more AI/ML models based on a corresponding model validity.

In example 14, which can also include one or more of the examples described herein, the conditions correspond to: a signal-to-noise ratio (SNR), a measured doppler value, a delay spread, a signal interference level, or a combination thereof.

In example 15, which can also include one or more of the examples described herein, the one or more processors are configured to cause the device to: receive the one or more AI/ML models from an over-the-air (OTA) server; and receive configuration information for the one or more AI/ML models from the OTA server, the configuration information comprising the conditions.

In example 16, which can also include one or more of the examples described herein, the one or more processors are configured to cause the device to: refrain from deploying at least one AI/ML model of the one or more AI/ML models when conditions corresponding to the AI/ML models are not acceptable.

In example 17, which can also include one or more of the examples described herein, the one or more processors are configured to cause the device to: when the one or more AI/ML models are determined to be invalid, fallback to evaluating and selecting beam pairs based on measured RSRPs of beam pairs.

In example 18, which can also include one or more of the examples described herein, a server device can comprise: a memory; and one or more processors configured to, when executing instructions stored in the memory, cause the server device to: create and train one or more artificial intelligence (AI)/machine learning (ML) models for beam management spatial prediction; determine model configuration information for the one or more AI/ML models; communicate the one or more AI/ML models and the model configuration information to a user equipment (UE); and receive, from the UE, a performance score corresponding to at least one AI/ML model of the one or more AI/ML models.

In example 19, which can also include one or more of the examples described herein, the configuration information comprises one or more conditions for deploying the one or more AI/ML models at the UE, and the performance score comprises an indication of whether the one or more AI/ML models is valid.

In example 20, which can also include one or more of the examples described herein, a method can comprise: determining measurements for beam pairs associated with a set of transmission (Tx) beams and a Tx beam pattern; determining whether conditions associated with deploying one or more artificial intelligence (AI)/machine learning (ML) models are satisfied; determining whether a data distribution of output data of each AI/ML model of the one or more AI/ML models is valid, the output data comprising predicted reference signal received powers (RSRPs) of a plurality of beam pairs; and determining, for the one or more AI/ML models with a valid data distribution, a model validity based on the predicted RSRPs of the plurality of beam pairs and measured RSRPs of the plurality of beam pairs.

A method can comprise: determining measurements for beam pairs associated with a set of transmission (Tx) beams and a Tx beam pattern; determining whether conditions associated with deploying one or more artificial intelligence (AI)/machine learning (ML) models are satisfied; determining whether a data distribution of output data of each AI/ML model of the one or more AI/ML models is valid, the output data comprising predicted reference signal received powers (RSRPs) of a plurality of beam pairs; and determining, for the one or more AI/ML models with a valid data distribution, a model validity based on the predicted RSRPs of the plurality of beam pairs and measured RSRPs of the plurality of beam pairs.

The above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art can recognize.

In this regard, while the disclosed subject matter has been described in connection with various examples, implementations, aspects, etc., and corresponding Figures, where applicable, it is to be understood that other similar aspects can be used or modifications and additions can be made to the disclosed subject matter for performing the same, similar, alternative, or substitute function of the subject matter without deviating therefrom. Therefore, the disclosed subject matter should not be limited to any single example, implementation, or aspect described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature can have been disclosed with respect to only one of several implementations, such feature can be combined with one or more other features of the other implementations as can be desired and advantageous for any given application.

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description or the claims, such terms are intended to be inclusive in a manner similar to the term “comprising.” Additionally, in situations wherein one or more numbered items are discussed (e.g., a “first X”, a “second X”, etc.), in general the one or more numbered items can be distinct, or they can be the same, although in some situations the context can indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled to minimize risks of unintentional or unauthorized access or use, and the nature of authorized use should be clearly indicated to users.

What is claimed is:

1. A device, comprising:
a memory; and
one or more processors configured to, when executing instructions stored in the memory, cause the device to:
determine measurements for beam pairs associated with a set of transmission (Tx) beams and a Tx beam pattern;
determine whether conditions associated with deploying one or more artificial intelligence (AI)/machine learning (ML) models are satisfied;
determine whether a data distribution of output data of each AI/ML model of the one or more AI/ML models is valid, the output data comprising predicted reference signal received powers (RSRPs) of a plurality of beam pairs; and
determine, for the one or more AI/ML models with the valid data distribution, a model validity based on the predicted RSRPs of the plurality of beam pairs and measured RSRPs of the plurality of beam pairs.

2. The device of claim 1, wherein the one or more processors are configured to cause the device to:
select at least one beam pair based on a predicted RSRP of a valid AI/ML model; and
communicate with the base station using the at least one beam pair.

3. The device of claim 1, wherein:
the device comprises a user equipment (UE), or
the device comprises baseband circuitry.

4. The device of claim 1, wherein the one or more AI/ML models is configured to generate the output data based on the beam pairs associated with a set of transmission beams and the Tx beam pattern.

5. The device of claim 4, wherein the output data comprises a full RSRP map for all beam pairs.

6. The device of claim 5, wherein the output data comprises a top number of beam pairs with the highest RSRP values.

7. The device of claim 6, wherein the plurality of beam pairs comprises the top number of beam pairs.

8. The device of claim 1, wherein the model validity is based on a degree of accuracy of the predicted RSRPs of the plurality of beam pairs relative to the measured RSRPs of the plurality of beam pairs.

9. The device of claim 1, wherein the one or more processors are configured to cause the device to:
determine model validity metrics for the plurality of beam pairs based on the RSRPs and the measured RSRPs of the plurality of beam pairs; and
the model validity is further based on a smoothing function applied to the model validity metrics.

10. The device of claim 1, wherein the measurements for the beam pairs are determined based on a combination of Tx beams and corresponding receiving (Rx) beams of a beam sweep.

11. The device of claim 1, wherein the one or more processors are configured to cause the device to:
determine a top number of beam pairs based on the predicted RSRPs;
communicate an indication of the top number of beam pairs to a base station; and
determine the measured RSRPs based on a transmission of the top number of beam pairs.

12. The device of claim 1, wherein the one or more processors are configured to cause the device to:
determine performance score for each AI/ML model of the one or more AI/ML models based on the predicted RSRPs of the plurality of beam pairs and measured RSRPs of the plurality of beam pairs.

13. The device of claim 12, wherein the one or more processors are configured to cause the device to:
update a locally stored record of each AI/ML model of the one or more AI/ML models based on a corresponding model validity.

14. The device of claim 1, wherein the conditions correspond to:
a signal-to-noise ratio (SNR),
a measured doppler value,
a delay spread,
a signal interference level, or
a combination thereof.

15. The device of claim 1, wherein the one or more processors are configured to cause the device to:
receive the one or more AI/ML models from an over-the-air (OTA) server; and
receive configuration information for the one or more AI/ML models from the OTA server, the configuration information comprising the conditions.

16. The device of claim 1, wherein the one or more processors are configured to cause the device to:
refrain from deploying at least one AI/ML model of the one or more AI/ML models when conditions corresponding to the AI/ML models are not acceptable.

17. The device of claim 1, wherein the one or more processors are configured to cause the device to:
when the one or more AI/ML models are determined to be invalid,
fallback to evaluating and selecting beam pairs based on measured RSRPs of beam pairs.

18. A server device, comprising:
a memory; and
one or more processors configured to, when executing instructions stored in the memory, cause the server device to:
create and train one or more artificial intelligence (AI)/machine learning (ML) models for beam management spatial prediction;
determine model configuration information for the one or more AI/ML models;
communicate the one or more AI/ML models and the model configuration information to a user equipment (UE); and
receive, from the UE, a performance score corresponding to at least one AI/ML model of the one or more AI/ML models.

19. The server device of claim 18, wherein:
the configuration information comprises one or more conditions for deploying the one or more AI/ML models at the UE, and
the performance score comprises an indication of whether the one or more AI/ML models is valid.

20. A method, performed by a user equipment (UE), the method comprising:
determining measurements for beam pairs associated with a set of transmission (Tx) beams and a Tx beam pattern;
determining whether conditions associated with deploying one or more artificial intelligence (AI)/machine learning (ML) models are satisfied;
determining whether a data distribution of output data of each AI/ML model of the one or more AI/ML models is valid, the output data comprising predicted reference signal received powers (RSRPs) of a plurality of beam pairs; and
determining, for the one or more AI/ML models with a valid data distribution, a model validity based on the predicted RSRPs of the plurality of beam pairs and measured RSRPs of the plurality of beam pairs.
